(19) United States
(12) Patent Application Publication
(10) Pub. No.: US 2021/0334441 A1
(43) Pub. Date: Oct. 28, 2021

(54) APPARATUS AND SYSTEMS FOR POWER SYSTEM PROTECTIVE RELAY CONTROL USING REINFORCEMENT LEARNING

(71) Applicant: The Texas A&M University System, College Station, TX (US)

(72) Inventors: Dongqi Wu, College Station, TX (US); Xiangtian Zheng, College Station, TX (US); Le Xie, College Station, TX (US); Dileep Kalathil, College Station, TX (US); Miroslav Begovic, College Station, TX (US)

(21) Appl. No.: 17/242,947

(22) Filed: Apr. 28, 2021

Related U.S. Application Data
(60) Provisional application No. 63/016,697, filed on Apr. 28, 2020.

(51) Int. Cl. G06F 30/27; H02H 7/22; G01R 21/06

(52) U.S. Cl. CPC G06F 30/27; G06F 2113/04; G01R 21/06; H02H 7/222

(57) ABSTRACT

A method for determining a control architecture for a network of protective relays of a power distribution system. The method includes receiving data specifying a topology of a plurality of relays in the network of protective relays. The method includes sequentially modelling each relay in the network of protective relays using a reinforcement learning algorithm, including modelling each relay as an agent configured to detect one or more local conditions on the power distribution system and configured to trip based on the one or more local conditions. The method includes determining, based on the sequential modelling, one or more control parameters for each relay in the network of protective relays.

### PRIORITY CLAIM

This application claims the benefit of U.S. Provisional Patent Application Serial No. 63/016,697 filed Apr. 28, 2020, the disclosure of which is incorporated herein by reference in its entirety.

### GOVERNMENT INTEREST

This invention was made with government support under contract number ECCS1839616 awarded by the National Science Foundation. The government has certain rights in the invention.

### BACKGROUND

The subject matter described in this specification relates generally to power distribution systems and in particular to control architectures for protective relay setting in power distribution systems.

Some conventional power distribution systems use protective relays to protect equipment. The goal of protective relays is to detect abnormal conditions, such as short circuit and equipment failures, and isolate the corresponding elements to prevent possible cascading destruction. The key design criteria for protective relays in the power distribution system is to properly isolate faults under abnormal conditions while not tripping under normal operating conditions. Since the protective relays are installed at all the nodes and branches, tripping of a protective relay would have consequences beyond the immediate neighboring device in the system. Therefore, the art and science of designing a protective relay system lies in how to trade-off different protective relay tripping during faulty situations. With increasing level of uncertainties in line flow patterns due to distributed energy resources, the design of an intelligent relay system has become the key engineering challenge to fully realize the potential of a truly low-carbon energy system in the future.

There are many traditional power system protection techniques that are widely used in the industry currently, including overcurrent, distance and differential relays. Traveling-wave fault location is a newer technology that recently got attention from the industry. Overcurrent protection is the most widely used method is power distribution systems due to the need to account for branching in distribution systems. Many machine learning methods focusing on improving power system protection have been developed. Studies include using neural-network to determine the parameters of overcurrent protection and using Support Vector Machine to directly determine the relay operation. Many proposed methods require communication between relays in the systems or between relay and a centralized data center, which makes commercial application in distribution systems impractical due to infrastructure limitations.

### SUMMARY

This specification describes a Reinforcement Learning (RL) based apparatus and system for optimal protection control for a network of relays in a power distribution system. The systems describe in this specification may have superior performance in many aspects over other traditional and recently developed approaches in power distribution system protection.

The computer systems described herein can be implemented in software in combination with hardware and/or firmware. For example, the subject matter described herein can be implemented in software executed by a processor. In one example implementation, the subject matter described herein may be implemented using a computer readable medium having stored thereon computer executable instructions that when executed by the processor of a computer control the computer to perform steps.

Example computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF DRAWINGS

FIG. 1 is a flowchart illustrating an example method for interfacing an RL-based protective relay into an existing power system;

FIG. 2A shows a node test feeder;

FIG. 2B shows protective relays in a radial network;

FIGS. 3A-3F show convergence plots of agents and comparison of robustness;

FIG. 4 shows the impact of a distributed generator on feeder protection;

FIGS. 5A and 5B are learning curves of RL relays;

FIG. 6 is a block diagram illustrating the concept of overcurrent and RL protection;

FIG. 7 shows protective relays in a radial line;

FIG. 8 is a block diagram illustrating an example model structure of an RL relay;

FIG. 9 shows pre-fault and faulted current distribution at Bus 800 in an example test system.

### DESCRIPTION

This specification describes three components for controlling a network of relays in a power distribution system:

1) Formulation of the decision-making problem of protective relays in power distribution systems as a dynamic Markov Decision Process problem. Each relay is modelled as an “Agent” that observe the system using local voltage and current measurement and use a control law, or policy, to determine their action (trip/hold) for each incoming measurement. When there are multiple relays in the system, the protective relay decision problem is formulated as a Multi-Agent Reinforcement Learning problem.

2) A Nested Reinforcement Learning algorithm that can be used to compute the optimal policy for the relays. In practice, it is very common that multiple relays collaboratively protect a network. When there are multiple agents in the system, computing the optimal policy is impractical using other methods. The Nested Reinforcement Learning algorithm takes advantage of the structural properties of power distribution systems and train the agents sequentially in an appropriate order according to the dependency of their operation goals. This algorithm allows the use of commonly-used single-agent training algorithms in the multi-agent problem, which the power distribution system is modelled as.

3) An interface design that can integrate the proposed RL relay algorithm with practical power systems. The RL relay uses stored voltage and current measurements from instrument transformers at the installation location of the relay. The RL Agent determines the optimal control policy to control a countdown timer, which controls a breaker/recloser to alter the circuit connectivity. The countdown timer provides the necessary operation delay to facilitate the coordination between different protection devices in the same circuit.

The methods described in this specification formulate the power system as a dynamical system, while almost all other methods used in power system protection treat the power system as static. The proposed method can reliably detect faults in cases where the fault current is small, such as high-impedance faults and faults in systems that have high Inverter Based Resources penetration.

The systems and methods described in this specification may have many advantages over traditionally used and recent machine-learning based methods: 1) Almost all other methods treat the power system as static and do not explicitly explore the dynamic nature of protective relay settings. 2) Many advanced methods require communication between relays in the system to achieve good performance, while the proposed method does not assume any communication. This is particularly useful in distribution systems because most existing infrastructures do not have communication lines and adding them would be expensive. 3) In preliminary studies on simulation, the proposed method has shown superior performance in metrics including failure rate, robustness and response speed. 4) Implementation of the proposed method is simple. The RL relay engine can be trained in a computer, then the parameters obtained in training can be easily programmed on a general-purpose microcontroller or machine learning chip. 5) The proposed method is capable of detecting high-impedance faults during which the magnitude of fault current is not significantly larger than normal operating current. Threshold-based methods, including almost all traditional and most recently developed methods, struggle in identifying high-impedance faults because they are designed based on the assumption that the magnitude of fault current is always much larger (usually 5 times over) than the current under normal condition.

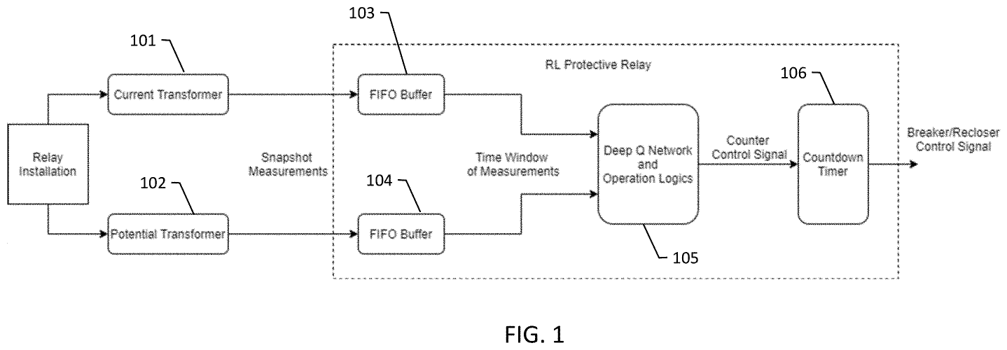

FIG. 1 is a flowchart illustrating an example method for interfacing the RL-based protective relay into an existing power system. The dashed block is the core components of an RL based relay which implements the concepts described in this specification.

Voltage and current measurements can be taken from the same pole/tower where the relay will be installed, potentially from instrument transformers 101 and 102 installed next to the relay. The measurement equipment can be, e.g., equipment that are currently used by the industry and are compatible with the RL relay. The measurement values can be saved in a FIFO ring buffer 103 and 104 for a short duration to form a time window of consecutive measurements which includes the newest measurement and several nearest past measurements. All data in the two FIFO buffer will be the input of a Deep-Q-Network (DQN). Other fault detection strategies could potentially be used in conjunction with the RL based protection 105. The DQN will output the appropriate control signal for the countdown timer 106 if a fault is detected in the circuit. This control signal will determine the appropriate time delay to facilitate coordination (if needed). If the countdown ends without being interrupted by the relay, it will send a trip signal to the breaker installed at the relay's location.

Examples of the methods and systems described in this specification are further described below with reference to three papers, titled “Nested Reinforcement Learning Based Control for Protective Relays in Power Distribution Systems,” “Adaptive Protective Relay Control in Future Power Distribution Systems,” and “Deep Reinforcement Learning-Based Robust Protection in DER-Rich Distribution Grids.”

Nested Reinforcement Learning Based Control for Protective Relays in Power Distribution Systems

I. Introduction

This paper is motivated by the increasing need to redesign the control architecture of protective relays in the power distribution systems. The goal of protective relays is to detect abnormal conditions, such as short circuit and equipment failures, and isolate the corresponding elements to prevent possible cascading destruction. The key design criteria for protective relays in the power distribution system is to properly isolate faults under abnormal conditions while not tripping under normal operating conditions. Since the protective relays are installed at all the nodes and branches, tripping of a protective relay would have consequences beyond the immediate neighboring device in the system. Therefore, the art and science of designing a protective relay system lies in how to trade-off different protective relay tripping during faulty situations. With increasing level of uncertainties in line flow patterns due to distributed energy resources, the design of an intelligent relay system has become the key engineering challenge to fully realize the potential of a truly low-carbon energy system in the future. This paper directly addresses this challenge of how to re-design the protective relay systems in the distribution grid.

This paper focuses on the re-design of the control logic for overcurrent relays. Overcurrent relays are the most widely used protective relays in the power grid. Overcurrent relays use the current magnitude as the indicator of faults. When a short-circuit fault occurs, the fault current is typically much larger than the nominal current under the normal conditions. The operating principle of this kind of relay is to trip the line if the measured current exceeds a pre-fixed threshold. This threshold is usually determined based on a number of heuristics that account for the topology of the network and feeder capacity.

In the case of possible operation failure of any relay, some coordination between adjacent relays is necessary to avoid catastrophic outcomes. This is typically achieved with a primary-backup relay coordination. If a faults occurs in the assigned region of a given relay, it should act as the primary relay and trip. If (and only if) the primary relay fails to trip, the adjacent upstream (towards the substation) relay should trip. Since there is no explicit communication between the relays, this coordination is achieved implicitly using an ‘inverse time curve’ [1]. If the primary relay fails, the backup relay will work but only after some time delay indicated by the inverse time curve.

Successful operation of conventional overcurrent relays rely on two crucial assumptions: (i) nominal operation currents are ignorable comparing to fault current, (ii) fault current magnitudes are always higher for faults that are closer to the substation. Both assumptions will be rendered invalid in field operations especially with the increasing penetration of distributed energy resources which allows much lower short-circuit current due to power electronics thermal limit and may cause power flow reversal under certain scenarios.

An efficient control algorithm for relay protection should be able to: (i) reduce the operation failures as low as possible, (ii) identify the fault as soon as possible, and (iii) adapt robustly against the changes in the operating conditions, like shift in the load profile. A unified approach that can exploit the availability of huge amounts of real-time sensor data from the power distribution systems, recent advances in machine learning, along with domain knowledge of the power systems operations is necessary to achieve these objective, especially in the context of next generation power systems. Most studies of improving the performance of the over-current relays focus on the aspects of coordination [2], fault detection [3] and fault section estimation [4]. Among various possible methods, machine learning is popular for advanced over-current relays. Neural networks [5] are applied to determine the coefficients of the inverse-time over-current curve. Other research work based on support vector machine [6] directly determine the operation of relays. However, most of these learning techniques do not explicitly explore the dynamic nature of the protective relay setting. As the power network grows in its complexity and flow patterns, it is often difficult to differentiate normal setting from a faulty one simply from a snapshot of measurements.

Reinforcement learning (RL) is a class of machine learning that focuses on learning to control unknown dynamical systems. Unlike the other two classes of machine learning, supervised learning and unsupervised learning, which typically focus on static systems, RL methodology explicitly includes the tools to characterize the dynamical nature of the system that it tries to learn. Last few years have seen significant progresses in deep neural networks based RL approaches for controlling unknown dynamical systems, with applications in many areas like playing games [7] and robotic hand manipulation [8]. This has also led to addressing many power systems problems using the tools from RL, as detailed in the survey [9]. RL is indeed the most appropriate machine learning approach for a large class of power systems problems because of the inherent stochastic and dynamical nature of the power systems. However, little effort has been made for using RL for relay protection control. The closest work [10] discusses about using a centralized Q-learning algorithm to determine the protection strategy for a relay network with full communication between them. The prerequisite of global communication leaves this method impractical.

We propose a novel nested reinforcement learning algorithm for optimal relay protection control for a network of relays in a power distribution network. We don't assume any communication between the relays. We formulate the relay protection control as a multi-agent RL problem where each relay acts as an agent, observes only its local measurements and takes control actions based on this observation. Multi-agent RL problems are known to be intractable in general and convergence results are sparse. We overcome this difficulty by cleverly exploiting the underlying radial structure of power distribution systems. We argue that this structure imposes only a one directional influence pattern among the agents, starting from the end of feeder line to the substation. Using this structure, we develop a nested training procedure for the network of relays. Unlike generic multiagent RL algorithms which often exhibit osculations and even non-convergence in training, our nested RL algorithm converges fast in simulations. The converged policy far outperforms the conventional threshold based relay protection strategy in terms of failure rates, robustness to change in the operation conditions, and speed in responses.

II. Background and Problem Formulation

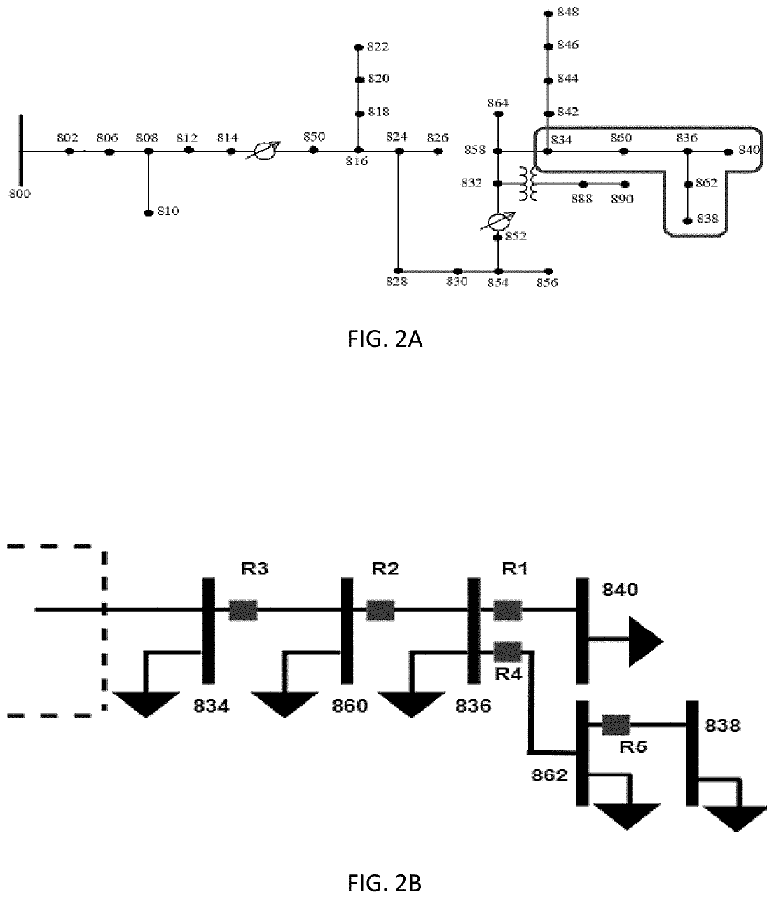

Relay Operation: In order to precisely characterize the operation of over current protective relays, the ideal operation of relays is first explained using a concrete setting given in FIG. 2B. This is a small section of the larger standard IEEE 34 node test feeder [11] shown in FIG. 2A. There are five relays protecting five segments of the distribution line.

Desirable operation of the relays is as follows. Each relay is located to the right of a bus (node). Each relay needs to protect its own region, which is between its own bus and the first down-stream bus. Relays are also required to provide backup for its first downstream neighbor: when its neighbor fails to operate, it needs to trip the line and clears the fault. For example, in FIG. 2B, if a fault occurs between bus 862 and 838, relay 5 is the main relay protecting this segment and it should trip the line immediately. If relay 5 fails to work, relay 4, which provides backup for relay 5, needs to trip the line instead.

Before formulating the relay protection problem using the RL approach, a brief review of some basic terminologies in RL is discussed below.

Markov Decision Processes (MDP) is a canonical formalism for stochastic control problems. The goal is to solve sequential decision making (control) problems in stochastic environments where the control actions can influence the evolution of the state of the system. An MDP is modeled as tuple (S, [symbol] , R, P, γ) where S is the state space, A is the action space. P=(P(⋅|s, α), (s, α) ∈S× [symbol] ) are the state transition probabilities. P(s′|s, α) specifies the probability of transition to s′ upon taking action a in state s. R:S× [symbol] → [symbol] is the reward function, and γ∈[0, 1) is the discount factor.

A policy π:S→ [symbol] specifies the control action to take in each possible state. The performance of a policy is measured using the metric value of a policy, V_{π}, defined as V_{π}(s)= [symbol] [Σₜ₌₀^{∞}γ^{t}Rₜ|s₀=S], where Rₜ=R(sₜ, αₜ), αₜ=π(sₜ), sₜ₊₁˜P(⋅|sₜ, αₜ). The optimal value function V* is defined as V*(s)=max_{π}V_{π}(s). Given V*, the optimal policy π* can be calculated using the Bellman equation as

$${π}^{*} ( s ) = {argmax}_{a ∈ 𝒜} ( R ( s , a ) + γ {\sum }_{{s}^{′} ∈ 𝒮} P ( {s}^{′} \vert s , a ) {V}^{*} ( {s}^{′} ) ) . \qquad ( 1 )$$

Similar to the value function, Q-value function of a policy π, Q_{π}, is defined as Q_{π}(s, α)= [symbol] [Σₜ₌₀^{∞}γ^{t}Rₜ|s₀=s, α₀=α]. The Optimal Q-value function Q* is defined similarly as Q*(s, α)=max_{π}Q_{π}(s, α). Optimal Q-value function will help us to compute the optimal policy directly without using the Bellman equation,

as π*(s)=arg max_{α∈A} Q*(s, α).

Reinforcement Learning (RL): Given an MDP formulation, V*, Q*; and π* can be computed using dynamic programming methods like value iteration or policy iteration. However, these dynamic programming method requires the knowledge of the full model of the system, namely, the transition probability P and reward function R. In most real world applications, the stochastic system model is either unknown or extremely difficult to model. In the protective relay problem, the transition probability represents all the possible variations in voltage and current in the network due to planned and random changes in the system. RL is a method for computing the optimal policy for an MDP when the model is unknown. RL achieves this without explicitly constructing an empirical model. Instead, it directly learns the optimal Q-value function or optimal policy from the sequential observation of states and rewards.

Q-learning is one of the most popular RL algorithms which learn the optimal Q* from the sequence of observations (sₜ, αₜ, Rₜ, sₜ₊₁). However, using a standard tabular Q-learning algorithm is infeasible in problems with continuous state/action space. To address this problem, Q-function is typically approximated using a deep neural network, i.e., Q(s, α)≈Q_{w}(s, α) where w is the parameter of the neural network. In Q-learning with neural network based approximation, the parameters of the neural network can be updated using stochastic gradient descent with step size α as

$$w = w + α ∇ {Q}_{w} ( {s}_{t} , {a}_{t} ) ( {R}_{t} + {γmax}_{b} {Q}_{w} ( {s}_{t + 1} , b ) - {Q}_{w} ( {s}_{t} , {a}_{t} ) ) \qquad ( 2 )$$

Additional upgrades to improve convergence performance including experience replay and targe network are added to the neural network approximation of Q learning to form the core of the DQN algorithm[7]. In the following, DQN will be used as one of the basic block for the proposed nested RL algorithm.

III. Nested Reinforcement Learning for Control of Protective Relays

We model the protective relays as collection of RL agents. Each relay knows its local measurements of voltage and current. Since we do not assume communication between relays, a relay i is not aware of downstream neighbors' actions or the exact location of the fault. So, each relay i needs a local control policy πᵢ that maps the local observation sᵢ to control action aᵢ, i.e., αᵢ=πᵢ(sᵢ). Since relays don't observe the measurements at other relays, an implicit coordination mechanism is also needed in each relay. This is achieved by including a local counter that ensures the necessary time delay in its operation as backup relay. These variables (voltage, current, breaker status, counter status) constitute the state sᵢ(t) of each relay i at time t .

To define the action space, we first specify the possible actions each relay can take. When a relay detects a fault it will decide to trip. However, to facilitate the coordination between the network of relays, rather than tripping instantaneously, it will trigger a counter with a time countdown, indicating the relay will trip after certain time steps. If the fault is cleared by another relay during the countdown, the relay will reset the counter to prevent mis-operation. The action of relay i at time t, αᵢ,t, is one of 11 possible values (reset the counter, set the counter to a value between 1 and 9, continue the counter).

The reward given to each relay is determined by its current action and fault status. A positive reward is given for a desirable operation and a negative reward is given for a wrong operation. The magnitude of the rewards are designed in such a way to facilitate the learning, implicitly signifying relative importance of false positives and false negatives.

Consider a network with n relays. Define the global state of the network at time t as s̅ₜ=(s_{1,t}, s_{2,t}, . . . , s_{n,t}) and the global action at time t as α̅ₜ=(α_{1,t}, α_{2,t}, . . . , α_{n,t}). Let R_{i,t} be the reward obtained by relay i at time t. It is clear from the description of the system that R_{i,t} depends on the global state s̅ₜ and global action α̅ₜ rather than the local state s_{i,t} and local action α_{i,t} of relay i. Define the global reward R̅ₜ as R̅ₜ=Σᵢ₌₁ⁿR_{i,t}. Note that the (global) state evolution of the network can no longer be described by looking at the local transition probabilities because the control actions of the relays affect each others' states.

We formulate the optimal relay protection problem in a network as multi-agent RL problem. The goal is to achieve a global objective, maximizing the cumulative reward obtained by all relays, using only local control laws. Formally,

$${max}_{{( {π}_{i} )}_{i = 1}^{n}} 𝔼 [ {\sum }_{t = 0}^{∞} {γ}^{t} {\overline{R}}_{t} ] , {a}_{i , t} = {π}_{i} ( {s}_{i , t} ) . \qquad ( 3 )$$

Since the model is unknown and there is no communication between relays, each relay has to learn its own local control policy πᵢ using an RL algorithm to solve (3).

Classical RL algorithms and their deep RL versions typically address only the single agent learning problem. A multi-agent learning environment violates one of the fundamental assumption needed for the convergence of

RL algorithms, namely, the stationarity of the operating environment. In a single agent system, for any fixed policy of the learning agent, the probability distribution of the observed states can be described using a stationary Markov chain. Multiple agents taking actions simultaneously violate this assumption. Moreover, in our setting, each relay observes only its local measurements which further complicates the problem. There are existing literatures [12] addressing this kind of problems, but the performance of most algorithms are unstable and the convergence is rarely guaranteed.

We propose an approach to overcome this difficulty of multi-agent RL problem by exploiting the radial structure of power distribution systems. Using this structural insight, we develop a nested RL algorithm to extend the single agent RL algorithm to the multi-agent setting we address.

We use the following training procedure. We start from the very end of the radial network in FIG. 2B. The relay protecting the last segment is relay 5, which has no downstream neighbors and can be trained using the single-agent training algorithm described in the previous section. Once the training of relay 5 is complete, it will react to the system dynamics using its learned policy. Since relay 5 only needs to clear local faults (i.e. faults between bus 862-838) and ignores disturbances at any other location, its policy will not change according to the change in the policy of other relays. This enables us to train relay 4 with relay 5 operating with a fixed policy (which it learned via the single agent RL algorithm). Since the policy of relay 5 remains fixed when training relay 4, the environment from the perspective of relay 4 remains more or less stationary (except for the possible disturbances due to difference in the local measurements). Similarly, after the training of relay 4 and 1 is complete, relay 2 can be trained with the policy of relay 1, 4 and 5 fixed. This process can be repeated for all the relays upstream to the substation.

This nested training approach which exploits the nested structure of the underlying physical system allows us to overcome the non stationarity issues presented in generic multi-agent RL settings. Our nested RL algorithm is formally presented in Algorithm 1.

Algorithm 1 Nested RL for Radial Relay Network

Sort {i|1 ≤ i ≤ n} into a vector N by the ordering of
training
Initialize replay buffer of each relay Nᵢ,1 ≤ i ≤ n
Initialize DQN of each relay i with random weights wᵢ
for relay i = 1 to n do

for episode k = 1 to M do

Initialize simulation with randomly system parame-
ters
for time step t = 1 to T do

Observe the state s_{i,t} of each relay Nᵢ
for relay j = 1 to i do

With probability ϵ select a random action a_{j,t},
otherwise select a greedy action
a_{j,t} = arg maxₐ Q_{w}_{ⱼ} (s_{j,t}, a)
Observe the reward R_{j,t} and next state s_{j,t+1}
Store (s_{j,t}, a_{j,t}, R_{j,t}, s_{j,t+1}) in the replay buffer
of relay Nⱼ
Sample a minibatch from replay buffer and
update wⱼ

end for
for relay j = i + 1 to n do

Select the null action, a_{j,t} = 0

end for

end for

end for

end for

IV. Simulation Results

In this section we evaluate the performance of our RL algorithm for protective relays. We compare its performance with the conventional threshold based relay protection strategy. We compare the performance in the following metrics:

Failure rate: We evaluate the operation failures of relays in four different scenarios: when there is a: (i) fault in the local region, (ii) fault in the immediate downstream region, (iii) fault in a remote region, (iv) no fault in the network.

Robustness to changes in the operating conditions: Relays are trained for a given operating condition, like a specific load profile. We evaluate protective relay strategies when there are changes in such operating conditions.

Response time: Relay protection control is supposed to work immediately after a fault occurs. We evaluate the time taken between the occurrence of a fault and activation of the protection control.

A. Simulation Environment Implementation

We choose the network shown in FIG. 2A for simulations. In particular, we focus on the section of the network shown in FIG. 2B. We implemented the environment using Siemens PSS/E. The simulation process is controlled by Python using the official PSSPY interface and the dynamic simulation module. The training is divided into episodes. In the beginning of each episode, a random initial operating condition (e.g. generator output, load size) is selected to mimic the load variation in distribution systems. During an episode, a fault is added to the system at a random time-step. The fault is set to have random fault impedance and occurs at a random location. Each relay has a probability to ignore a trip action. This corresponds to the case when the breaker fails as a relay tries to trip the line, and the backup need to trip instead.

B. RL Algorithm Implementation and Training

The RL algorithm is implemented using the open-source library Keras-RL [13]. A TCP/IP port and codec are also used to enable data exchange between PSS/E and RL modules due to their incompatibility. Algorithm 1 is implemented using this setup. The final configuration and hyperparameters are specified in Table I. We chose the discount factor γ=0:95 and the mean square error as the loss function.

TABLE I
DQN Agent Hyperparameters

| Hyperparameter | Value |
|---|---|
| Hidden Layers and Size | 2 Layers, 64 × 32 |
| Replay Buffer and Batch Size | 10000, 32 |
| Optimizer and Learning Rate | Adam, 0.0005 |

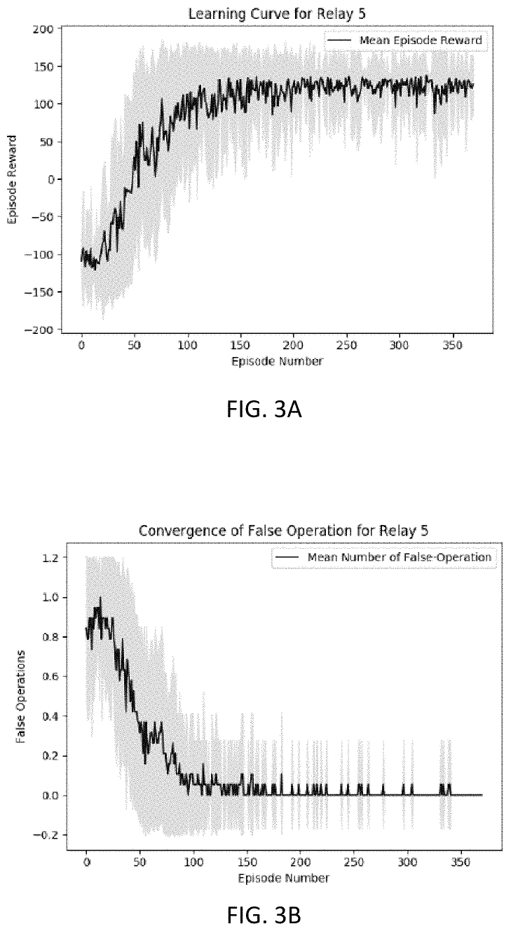

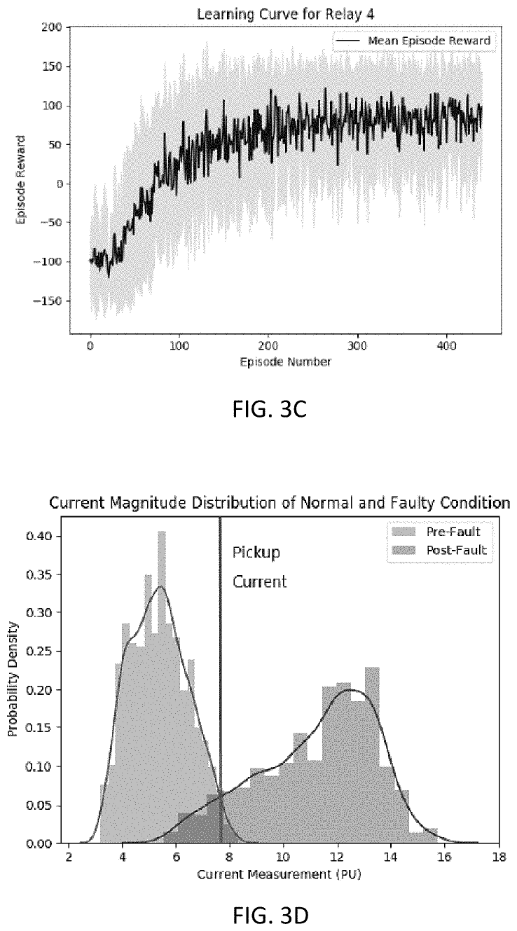

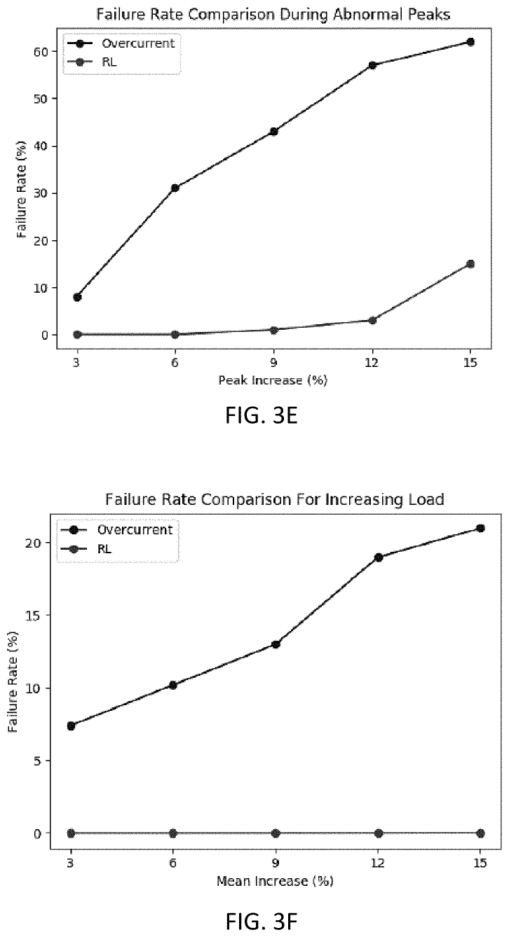

FIG. 3A shows the convergence of episodic reward for relay 5. The thick line indicates the mean value of episodic reward obtained during a trial consisting of 20 independent runs of training. The shaded envelope is bounded by the mean reward±standard deviation recorded at the same progress during the trial. Note that the episode reward converges in less than 250 episodes. One episode takes roughly 3 seconds. So, the training converges in less than 750 seconds.

Similarly, FIG. 3B shows the convergence of false operations for relay 5. In the beginning of training, the false operation rate is really high but it soon converges to a value approximately zero. FIG. 3C shows the learning curve corresponding to the episodic reward of relay 4. The convergence is slower because relay 4 has to act both as primary relay and as backup for relay 5, while relay 5 only has to act as the primary relay (c.f. FIG. 2B). So, the control policy of relay 4 is more complex than the policy of relay 5, and hence it takes a longer training time to converge. We omit the learning curves for other relays as they are very similar to that of relay 5 and relay 4.

C. Conventional Relay Protection Strategy

Conventional relay protection strategies are based on a threshold rule, i.e., relay trips if and only if the measured current is greater than a fixed threshold. The optimal threshold is typically computed using a variety of heuristic methods [1]. Since these methods depend on the network parameters like topology, feeder capacity and load size, they may not give the optimal threshold that maximizes the success rate in our setting. So, for a fair comparison with a more powerful RL based algorithm, we compute the optimal threshold that gives the best performance through a simple statistical approach.

We compute the empirical probability distribution (pdf) of the current measurements before and after the fault from 500 episodes. For example, the pdf of the pre-fault and postfault current at bus 862 is plotted in FIG. 3D. It is clear from the figure that the distributions of the pre-fault and post-fault currents overlap with each other. This is expected, especially in the power distribution systems, where the load profile varies greatly with the time of day. Higher fault impedance can also limit the magnitude of fault current. We put a higher weight on faulty scenarios to overcome the imbalanced prior probabilities. The optimal threshold that will maximize the success rate can then be approximated as the crossing point of these two pdfs [14]. This point is marked as the ‘pickup current’ in the figure, and is used as the threshold for the conventional relay protection strategy.

D. Performance Evaluation

In this section we compare the performance of the RL based relay protection strategy and threshold based conventional relay protection strategy. As mentioned above, we focus on three metrics of performance, namely, failure rate, robustness, and response time.

Failure rate: A false operation of a relay is the one operation where that relay fails to operate as it supposed to do. There are two kinds of false operations, false-negative and falsepositive. A false-positive happens if: (i) relay trips when there is no fault, (ii) relay trips even if the location of fault is outside of the relay's assigned region, (iii) backup relay trips before the primary relay. A false-negative happens if: (i) relay fails to trip even if the location of the fault is inside its assigned region, (ii) backup relay fails to trip even after its immediate downstream relay has failed.

For the RL based algorithm, we use the parameters obtained after training. For the conventional relay strategy, we use the optimal threshold computed as described before. The performance is evaluated in four scenarios. Each scenario is tested with 5000 episodes. Failure rate is calculated as the ratio of the number of episodes with failed operations to the total number of episodes. Failure rate comparison is given in Table II. Note that our RL based algorithm remarkably outperforms the conventional relay strategy. For example, in the local fault scenario, the conventional strategy has a failure rate of 7.7% where as our RL algorithm has a mere 0.26%.

TABLE II
False Operation Rate Comparison

| | | Failure Rate | |
|---|---|---|---|
| Scenario | Expected Operation | Conventional | RL-based |
| Local Fault | Trip | 7.7% | 0.26% |
| Backup | Trip | 9.6% | 0% |
| Remote Fault | Hold | 3.8% | 0.08% |
| No Fault | Hold | 1.8% | 0% |

Also note that in two scenarios, backup and no fault, even after 5000 random episodes, RL based strategy didn't cause any operation failure. So, we put the failure rate as zero.

Robustness: Load profiles in a distribution system is affected by many events like weather, social activities, renewable generation, and electric vehicles charging schedules. These events can generally cause the peak load to fluctuate and possibly exceed the expected range in the planning stage. Moreover, the electricity consumption is expected to slowly increase each year, reflecting the continuing economy and population growth. This can cause a shift in the mean (and variance) of the load profile. Relay protection control should be robust to such changes as continually reprogramming relays after deployment is costly.

We first evaluate the robustness in the case of peak load variations. For the clarity of illustration, we focus on relay 5. We vary the peak load upto 15% more than the maximum load used during training. Since we are considering the robustness w.r.t. to the peak load variations, the load capacity used in this test is sampled only from peak load under consideration. For example, the data collected for 3% increase are sampled by setting the system load size between 100% and 103% of the peak load at training. We then test the performance of both relay strategies without re-training the RL relays.

The performance is shown in FIG. 3E. It can be seen that conventional relay strategy completely fails against such a change in the operating environment as it fails in more than 40% of such scenarios after a 9% increase in the peak load. On the other hand, RL algorithm is remarkably robust at this point with failures in less than 2% scenarios. RL algorithm performance starts to decay noticeably only after 15% increase in the peak load.

We also evaluate the robustness against increase in the mean load and the performance is shown in FIG. 3F. RL algorithm is remarkably robust even after a 15% increase in the mean load. Conventional relay strategy fails completely in this scenario also.

Response time: RL algorithm also shows a very fast tripping speed during the testing. We observed a tripping time of 0.005 second for the primary relay and 0.009 second for the backup relay. Conventional overcurrent relays uses the timeinverse curves as the ones defined in IEEE C37.112-2018 [15] to determine the time delay for all situations, which gives unnecessary delay even for operations as primary relays. Depending on the curve selected, the minimum delay is at least at the order of 0.1 second.

V. Concluding Remarks

This paper proposes a multi-agent reinforcement learning based approach for redesigning the control architecture of protective relay in power distribution systems. We propose a novel nested reinforcement learning algorithm that exploits the underlying physical structure of the network in order to overcome the difficulties associated with standard multiagent problems. Unlike the generic multi-agent RL algorithms which often fail to converge, our nested RL algorithm converges fast in simulations. The converged policy far outperforms the conventional threshold based relay protection strategy in terms of failure rates, robustness to change in the operation conditions, and speed in responses.

### REFERENCES

[1] J. M. Gers and E. J. Holmes, Protection of Electricity Distribution Networks, The Institution of Engineering and Technology, 3rd edition, 2011.
[2] H. Zhan, C. Wang, Y. Wang, X. Yang, X. Zhang, C. Wu, and Y. Chen, “Relay protection coordination integrated optimal placement and sizing of distributed generation sources in distribution networks”, IEEE Transactions on Smart Grid, 2016, vol. 7, no. 1, pp. 55-65
[3] P. Dash, S. Samantaray, and G. Panda, “Fault classification and section identification of an advanced series-compensated transmission line using support vector machine”, IEEE transactions on power delivery, 2007, vol. 22, no. 1, pp. 67-73
[4] H.-T. Yang, W.-Y. Chang, and C.-L. Huang, “A new neural networks approach to on-line fault section estimation using information of protective relays and circuit breakers”, IEEE Transactions on Power delivery, 1994, vol. 9, no. 1, pp. 220-230
[5] P. Mahat, Z. Chen, B. Bak-Jensen and C. L. Bak, “A Simple Adaptive Overcurrent Protection of Distribution Systems With Distributed Generation”, IEEE Transactions on Smart Grid, 2011, vol.2, no.3, pp 428-437
[6] X. Zheng, X. Geng, L. Xie, D. Duan, L. Yang and S. Cui, “A SVMbased setting of protection relays in distribution systems”, 2018 IEEE Texas Power and Energy Conference (TPEC), 2018, College Station, TX, pp. 1-6.
[7] V. Minh et al., “Human-level control through deep reinforcement learning”, Nature, 2015, 518.7540:529
[8] S. Levine, C. Finn, T. Darrell and P. Abbeel, “End-to-end training of deep visuomotor policies”, The Journal of Machine Learning Research, 2016, vol. 17, no. 1, pp. 1334-1363
[9] M. Glavic, R. Fonteneau and D. Ernst, “Reinforcement Learning for Electric Power System Decision and Control: Past Considerations and Perspectives”, IFAC-PapersOnLine, 2017, vol. 50, no. 1, pp. 6918-6927
[10] H. C. Kilic, kiran, B. Kekezoglu and G. N. Paterakis, “Reinforcement Learning for Optimal Protection Coordination”, 2018 International Conference on Smart Energy Systems and Technologies (SEST), Sevilla, 2018, pp. 1-6
[11] IEEE Distribution System Analysis Subcommittee, “Radial Test Feeders”, [Online], 2019, Available: http://sites.ieee.org/pestestfeeders/resources/
[12]S. Kapoor, “Multi-Agent Reinforcement Learning: A Report on Challenges and Approaches”, Computing Research Repository, arXiv, 2018, arXiv:1807.09427
[13] M. Plappert, keras-rl, GitHub Repository, [Online], 2016, Available:

https://github.com/keras-rl/keras-rl
[14] R. O. Duda, P. E. Hart and D. G. Stork, Pattern Classification, John Wiley & sons, 2nd edition, 2002.
[15] IEEE Standards Association, “C37.112-2018-IEEE Standard for Inverse-Time Characteristics Equations for Overcurrent Relays”, IEEE Standard, 2019, 10.1109/IEEESTD.2019.8635630

Adaptive Protective Relay Control in Future Power Distribution Systems

The protection of power systems is a crucial part of maintaining grid security. Protective relays isolate the grid from sustained faults by interrupting an electric connection and removing faulty components from the system while maintaining reliability and selectivity. As the power grid is undergoing tremendous changes with increasing penetration of renewable energy sources, distributed generations (DG) and flexible loads, the current system protection design is challenged by the need to correctly identify and locate faults under vastly different operating conditions. Particularly, it is very difficult for conventional overcurrent relay designs to accommodate the various challenges brought by DG. Thus, to handle these difficulties, a more adaptive protective relay control strategy is needed to effectively protect future distribution systems.

Motivated by the increasing need of re-designing the control architecture of protective relays in power distribution systems with DG, this work presents an adaptive relay control strategy adopting the latest machine learning technology. The proposed method is able to detect and locate faults both accurately and reliably, regardless of the operating condition of the system when fault happens. This method is also robust to unexpected operating conditions, remaining functional even when the power flow in the system exceeds the anticipated range during relay configuration. Time-delay coordination between relays or with fuses is also achieved. The biggest advantage of the proposed method lies in its ability to work blindly without any communication between relays, or between relay and data center. This makes implementation economically viable, since most distribution lines are not equipped with communication equipment.

A case study using the purposed relay control strategy is performed on a modified version of the IEEE 34 node test feeder system. The test case is implemented in PSS/E dynamic simulation. The relays are modelled in Python, trained and tested in the test environment using the PSS/E Python interface. The relays are evaluated on: 1) ability to correctly operate and coordinate with other protection devices; 2) robustness under unplanned system conditions; 3) post-fault response time. The RL relays show excellent performance in these aspects.

1. Introduction

Distributed Generation (DC) refers to the emerging approach to deploy power generation equipment near the load side in the power grid. In distribution networks, DG is usually composed by small scale renewable generation resources such as residential photovoltaic panels, wind turbines or diesel/gas turbines as backup generators in business or state facilities. DG equipment can benefit the grid in various ways such as peak reduction, power quality, providing ancillary services and improve reliability during disturbances [1]. Furthermore, DG can also benefit social welfare by reducing emission and electricity price by using renewable energy resources. However, despite all the benefits provided by DG, additional complexities are also introduced to the existing distribution system planning and operation. In conventional distribution systems, the power flow is always radial along the feeder from the substation to loads. With the introduction of DG, the power flow direction in each line can be reversed in certain cases when DG is feeding power back into the grid from the load side. This power flow reversal creates numerous problems in many aspects of the distribution grid such as voltage and frequency control, power imbalance, islanding, power flow control and line protection [2].

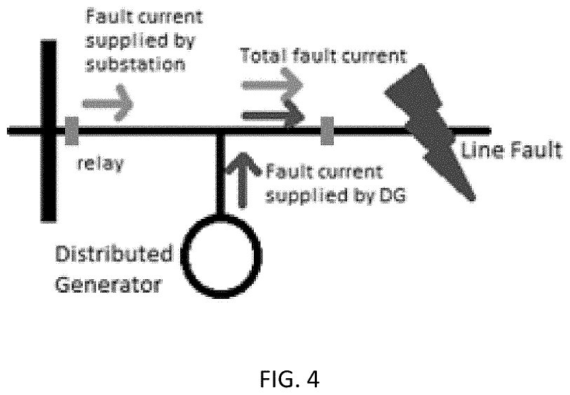

Increasing penetration of DG in distribution systems causes multiple challenges not only for current overcurrent protection scheme but also for advanced protection design. First, it is harder to accurately detect faults in a DG penetrated grid since the outputs of DG tend to vary wildly depending on weather, time, load conditions and their own schedules. Due to such property, more sudden and substantial variation of power flow under normal conditions is sometimes hardly distinguishable from system behaviors under fault conditions. Second, the fault current is hard to detect in distribution systems with power electronic interfaced DGs such as PV and wind turbines as the inverter cannot supply a fault current that is much larger than the rating current, thus limiting its magnitude and make it harder to distinguish from current under heavily loaded scenarios. Third, increasing system complexity introduces additional difficulties in evaluating appropriate parameters for overcurrent protection scheme. When there are multiple DGs installed in the system, it would be very hard to predict the fault current for each line under different load profiles, DG outputs and fault parameters. Last, accurate coordination between protection devices is hard to achieve when there are multiple sources in the feeder circuit. In the circuit shown in FIG. 4, the fault current passing through the lateral protection relay is supplied by both the substation and DG while the substation relay can only monitor the substation part. When the fault happens near the end of a long feeder, the substation part of fault current can be small due to the high line impedance, which causes the substation relay fails to detect the fault and coordinate with lateral protection. With the above considerations, it has been commonly acknowledged that overcurrent protection scheme cannot adapt the changes in modern distribution systems as presented in [2] and an advanced protection design is badly in need.

Many studies have been done to improve the performance of overcurrent relays in distributed generation systems. [3] and [4] focus on the coordination between relays; In [5] and [6], Artificial Neural Network (ANN) is used to determine the optimal time dial and pickup current for overcurrent relays; Other machine learning algorithms like Support Vector Machine (SVM) is also used in [7] and [8] to control the operation of relays. Most existing methods are still restricted in the time-delay overcurrent protection framework, which is not sufficient with the addition of DG for the reasons mentioned above.

This paper aims to address the protection problem in distribution systems using a Reinforcement Learning (RL) based relay model. Transition process of observations in distribution systems is modelled as a Markov Decision Process (MDP), where relays are decision makers that observe the system using local voltage and current measurement and use a control law to determine their action (trip/hold) for each incoming measurement. The goal of RL is to find an optimal control law for each relay that gives the correct action based on their observation.

2. Testing System Modelling

The standard IEEE 34 node test feeder [9] is chosen as the testbed for this study. The system one-line diagram is shown in FIG. 2A. The original case is a single-sourced radial distribution network in which the substation is connected to bus 800. The rated capacity of the substation transformer is 2500 kVA. The voltage level of the system is 24.9 kV, except for bus 888 and 890 to the right of the transformer between bus 832 and 838 being 4.16 kV. Protection devices are shown in FIG. 2A as blue boxes placed to protect the substation feeder and each lateral that goes out from the feeder. This protection scheme of the IEEE-34 node test feeder with DG was studied in existing literatures [10] and [11], which concluded that the addition of DG has negative impacts on the performance of protection relays and their coordination. In this paper, the proposed RL relays are trained and tested by running PSS/E dynamic simulation using the IEEE 34 node test case and the result is compared with traditional overcurrent relays whose performance was analyzed in [10] and [11].

Since the original test system does not include DG, we add several generator models at the load side of the feeder. Specifically, two types of generator models are included to represent different types of DG. A 500-kVA synchronous machine is place at node 840 to represent a gas turbine. The machine parameters are selected from the range of parameters for machines that have similar capacity and purpose, while the parameters of the governor are retrieved from a NERC recommendation [12] on modelling gas turbine governors. The model and parameters for the machine and exciter are listed below in Table 1:

TABLE 1
Machine and exciter model for synchronous DG at bus 840

| GENROE | | T″_{qo} | 0.066 | X_{q} | 1.68 | X₁ | 0.266 | SCRX | | T_{E} | 0.05 | r_{c}/r²_{fd} | 0 |
|---|---|---|---|---|---|---|---|---|---|---|---|---|---|
| T′_{do} | 5.3 | H | 2 | X′_{d} | 0.25 | S_{1.0} | 013 | T_{A}/T_{B} | 1 | E_{MIN} | −15 | | |
| T″_{do} | 0.035 | D | 0 | X′_{q} | 0.22 | S_{1.2} | 1.067 | T_{B} | 150 | E_{MAX} | 5 | | |
| T′_{qo} | 0.625 | X_{d} | 1.72 | X″_{d} | 0.14 | | | K | 150 | C_{SW} | 1 | | |

Several renewable generators of smaller capacity are also added to the lateral 838-848 to represent residential PV panels. They are modelled using the default PV converter model PVGU1 and controller model PVEU1 in PSS/E library. During the simulation process, the solar irradiation level is assumed be constant throughout the simulation since the length of each simulation segment is very short. All nodes that have DG installed are set as PV buses in the prior power flow calculation when initializing the dynamic simulation, with their voltage setpoint fixed at 1 per unit.

All load models in the system follow their original settings in the IEEE documentation, in which they are recorded as constant PQ, constant current or constant impedance loads with the same power factor of 0.894. However, during the training of the RL relays, the real and reactive power of the loads are randomized before each run of a simulation episode to represent natural load level fluctuation over time in distributed systems. The original test case also has two capacitor banks located at node 844 and 848 and two voltage regulators at the line 814-820 and 832-888. The capacitor bank states and tap of voltage regulators are fixed for all episodes at their initial value in the IEEE documentation. Finally, the transmission grid is modelled as an infinite bus of which voltage magnitude is set to 1.05 per unit.

3. Background and Relay Formulation as a Reinforcement Learning Problem

Before showing our formulation of the relay control problem in the RL framework, it is necessary to provide some rough backgrounds on MDP and

RL. MDP is a framework that helps modelling decision making problem in a discrete-time stochastic environment, in which the state of the system evolves base on the action made by the decision maker Agent. Formally, an MDP is defined as a tuple (S,A,P,R), where:

S is the set of states

A is the set of actions

Pa(s,s′) is the probability that the action a under state s will take the system to state s′

R(s,s′) is the reward received for transitioning from s to s′

In an MDP, each agent gives its control action according to a deterministic or probabilistic policy. A deterministic policy π is defined as a mapping π:S→A that specifies the action to take under each state. The performance of a policy π, the value function Vπ is defined for each state as the cumulative expected reward under policy π starting from that state:

$${V}_{π} ( s ) = E [ {\sum }_{t = 0}^{∞} {γ}^{t} {R}_{t} \vert {s}_{0} = s ]$$

where γ∈(0, 1) is the discount factor that is added to “discount” future rewards to ensure convergence. Similarly, the Q-value function Qπ that assign a value to every possible action under each state is defined as:

$${Q}_{π} ( s , a ) = E [ {\sum }_{t = 0}^{∞} {γ}^{t} {R}_{t} \vert {s}_{0} = s , {a}_{0} = α ]$$

The goal of solving an MDP is to find an optimal policy π* that gives the optimal action α*=π*(s), ∀s∈S that maximizes the expectation of future discounted cumulative reward:

$${π}^{*} ( s ) = {arg max}_{a ∈ A} [ R ( s , a ) + γ {\sum }_{{s}^{′} ∈ 𝒮} P ( {S}^{′} \vert s , a ) {V}^{*} ( {s}^{′} ) ]$$

where V*(s)=maxπ[Vπ(s)] is the optimal value function corresponding to the optimal policy π*. Similarly, the optimal Q-value function Q* is the Q-value function of π* that gives the expectation of discounted future reward for every action under each state. π* can be directly obtained using Q* as:

π*(s)=argmax_{α∈A}Q*(s, α)

As stated in [13], dynamic programming and reinforcement learning are two major techniques for solving MDP problems. Dynamic programming can compute the optimal control policy derived from the system model, i.e. transition probability matrix. In contrast, RL learns the optimal policy by collecting historical observation during iterative interaction with the environment, without the prior knowledge of the system model.

Q-learning is a popular RL algorithm that computes the optimal policy through constantly updating the Q-value function from sequential observations of state, action and reward by actively interacting with the environment. Formally, the optimal Q-value function QQ* is obtained iteratively using the following update rule:

Qₜ₊₁(sₜ, αₜ)=Qₜ(sₜ, αₜ)+η[Rₜ+γ max_{b}Qₜ(sₜ₊₁, b)−Qₜ(sₜ, αₜ)]

where η∈(0, 1) is the learning rate. The above iteration will eventually converge to Q* if each state-action pair is visited infinitely often and an appropriate η value is adopted. [13]. However, this is usually computationally impossible for most practical problems due to the dimension of state and action space, or infeasible due to the state or action space being continuous. Deep Reinforcement Learning (Deep-RL) addresses this problem by using an artificial neural network NQ to approximate the Q-value function [14] such that NQ(s,α)≈Q(s,α). Instead of updating the tabular Q-value for each state-action pair (s,α), the Deep-Q-Network (DQN) NQ can be trained to predict the approximate Q-value for each (s,α) combination by minimizing the difference between predictions and observations using optimization methods.

We formulate distribution system transient process as MDP, considering relays as agents, and further apply RL algorithm to compute optimal policies for relays. However, the following complications need to be addressed before moving forward. First, the relays can only observe local system states. This observation alone is obviously non-Markovian since the system's state evolution is also affected by the states at other locations, which is unavailable under a communication-free setting. A common way of getting around this problem is to expand the state space to include several past observations S_{ob}⁻. The agent can then calculate a belief β(S_{ob}⁻) that summarizes the history, which, together with current state, is Markovian [15]. Second, classic RL and Deep-RL algorithms can only solve single agent problems. Including multiple agents violates a fundamental assumption of MDP, which requires the environment to stay stationary. This can be solved by training relays sequentially in an appropriate order according to the dependency of their operation goals [16]. Lastly, to improve reliability, an implicit coordination between relays is also needed. Referring to overcurrent protective design, this is achieved by implementing a local time delay counter that provides the time delay whenever the relay needs to function as a backup for other protection devices. When a fault is detected by a relay, it triggers the counter such that the breaker will operate after a certain time delay. If the fault is cleared by the primary relay during the countdown, the relay will reset the counter to prevent unnecessary operation.

Taking the above complications into account, the decision-making problem for RL based protective relays is formulated under the MDP framework as the following:

The state space S={S_{V}, S_{C}, S_{B}, Sct} of each relay is:

S_{V}: Local voltage measurement, including the present and past m steps

S_{C}: Local current measurement, including the present and past m steps

S_{B}: Breaker status, 0—open, 1—closed

Sct: Current value of the time counter

The action space A={Aₛₑₜ, A_{cont}, A_{clear}} of each relay is:

Aset: Set the counter to value N∈Z+: (Sct←N)

Acont: Continue the counter (Sct←Sct−1)

Aclear: Stop and reset the counter

The reward RR for each RL relay depends on the system condition when an action is taken. During simulation, we know the precise time and location of each fault. A positive reward is given for a desirable operation, while a negative reward is given for an undesirable operation.

The reward R is set based on the following conditions:

+100: If the relay trips when there is a fault in its assigned protection region

−120: If the relay trips when there is no fault, or the fault is outside of its region

+5: If the relay stays closed when there is no fault, or the fault is outside of its region

−20: If the relay stays closed when there is a fault in its assigned region

4. Numerical Experiments

The testbed system described in Sec. 2 is set as the training environment for the RL relays. The system and model parameters are entered in PSS/E case and dynamic file for transient simulation. The simulation process is controlled automatically in Python using the Siemens PSSPY API. To provide the relays with a dynamic environment that matches the real behaviour of distribution systems, the simulation is performed in many separate episodes, which are short simulation segments that contains a fault. Each episode is initialized with random load level, DG output and fault parameter, which are selected randomly from a pre-set range of variation. For example, the real and reactive power of each load is set to a random number between 75% and 125% of their original value.

The RL relays are modelled using Tensorflow[17] and Keras-RL[18], which are public machine learning packages for research and applications. A TCP/IP port and codec are also used to enable data exchange between the simulator and RL modules due to their incompatibility in bitness. Through the communication port, the relays can control and interact with the simulator by sending encoded instructions.

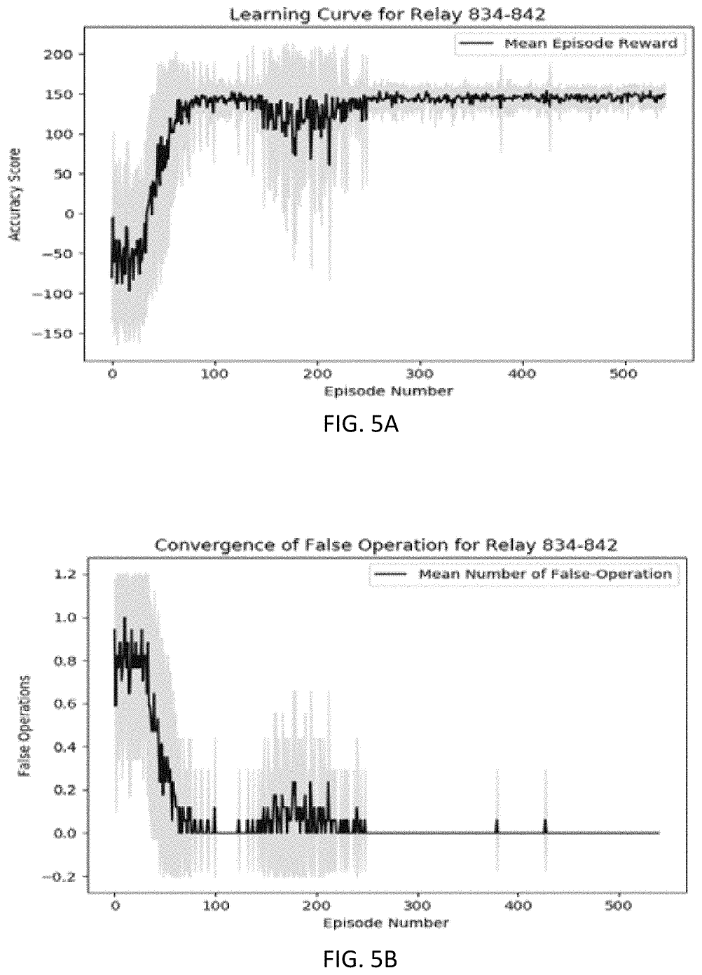

During training, each RL relay collects experience by going through different episodes and updates the DQN to determine the correct action at each time step. The training is terminated when the policy of a relay has converged. To demonstrate the training process, the learning curves of one lateral relay collected from 15 runs of independent training for a lateral is shown in FIGS. 5A and 5B. The bold black lines are the mean episodic reward (left) and mean number of false operations (right) obtained at the current progress; the grey envelope is the mean±standard deviation. The learning curve shows that the policy converges after running roughly 250 episodes.

The curves for all relays are similar, so others are omitted for simplicity.

5. Results and Discussions

In this section, the performance of the trained RL relays is evaluated and compared with traditional overcurrent approaches. The evaluation is performed under the same simulation environment with random parameters. The parameters of the DQNs of the relays are retrieved from the end of their training as described in Sec. 4. The RL relays are evaluated on three metrics: accuracy, robustness and response speed.

A. Accuracy

The first and most important metric for relay operation is accuracy. In this section, accuracy is defined as the rate of the protection system doing the desirable operation. When a fault occurs in a lateral, the corresponding lateral protection should be the first to operate. If the lateral protection fails, the substation relay should act as backup. When there is no fault, all relays should stay closed. During an episode, each relay is given its respective voltage and current measurement at the end of each time step, then it will decide whether to trip its breaker or not. The accuracy is evaluated at the end of each episode: an episode is considered unsuccessful if any relay has operated undesirably at any time step; or successful if all relay gave the correct response to the random fault throughout the whole episode. In the accuracy evaluation, 5000 episodes with random fault scenarios are tested and the numbers and types of unsuccessful episodes are recorded in the following table;

TABLE 2
Undesirable Operation of RL Relays
in 5000 Random Fault Scenarios

| | Incorrect | Desired | | |
|---|---|---|---|---|
| Scenario | Operation | Operation | Occurrence | Probability |
| Lateral Fault | Hold | Trip | 1/5000 | 0.02% |
| No Fault | Trip | Hold | 0/5000 | 0.00% |
| Remote Fault | Trip | Hold | 0/5000 | 0.00% |
| Coordination | Substation | Substation | 3/5000 | 0.06% |
| Failure | relay trips | relay trips | | |
| | before | when lateral | | |
| | lateral relay | relay fails | | |
| Total | | | 4/5000 | 0.08% |

The causes of these incorrect operations are inspected after the test, the one substation relay under-reach problem happened for a lateral fault at the line between 862 and 838 that had high fault impedance; the three coordination failures all occurred when the substation relay and the lateral relay tripped at the same time. The lateral relays all had perfect performance in the test due to their operation is relatively simple. Overall, the failure rate is very small and the RL relay system demonstrated good fault detection and coordination abilities.

B. Robustness

Robustness is defined as the ability of relays to work correctly under scenarios that are not expected during planning. In the long term, the operating condition of the relays may be affected by installation of new DGs, abnormal load size due to natural disasters, social events and EV charging. These factors can cause the current and voltage measured at the relays to vary significantly under both normal and faulty conditions. The robustness of relays against unplanned changes is also desired, since it might be a cause of mis-operation and re-programming deployed relays introduces additional cost. To evaluate robustness, the test environment is modified before performing the test in Sec. 5A. We add additional DG resources to the lateral between node 816 and 822 represented as negative load for simplicity, as the lateral is single-phase line in the original case. The DG provides random output from 25 kW to 100 kW real power. This will cause a significant change to the power flow in the lateral. The policy that controls relay 816 protecting that lateral remains the same as when it was trained without the newly added DG. The operation of relay 816 with and without the new DG is recorded in the following table;

TABLE 3
Incorrect operation of RL relay under unexpected conditions

| | Incorrect | Desired | Occurrence | Probability | Occurrence | Probability |
|---|---|---|---|---|---|---|
| Scenario | Operation | Operation | (Normal) | (Normal) | (New DG) | (New DG) |
| Local Fault | Hold | Trip | 0/2000 | 0.00% | 11/2000 | 0.55% |
| No Fault | Trip | Hold | 0/2000 | 0.00% | 0/2000 | 0.00% |
| Remote Fault | Trip | Hold | 0/2000 | 0.00% | 0/2000 | 0.00% |
| Total | | | 0/2000 | 0.00% | 11/2000 | 0.55% |

The addition of a new DG causes the RL relay to occasionally not react to lateral fault in a few cases. It could be caused by part of the fault currents for faults between 820 and 822 being supplied by DG and not seen by the relay as shown in FIG. 2A. Nevertheless, the RL relay still maintains a relatively high accuracy even after a new DG installation.

C. Response Speed

To prevent persisting fault causing damage to equipment, the response speed of protection devices is another important performance criterion. Particularly in situations where a recloser-fuse coordination is implemented. When a fault occurs in one of the laterals. It is desirable for the recloser to open as quickly as possible to prevent the fuse being melted by a transient fault, which can cause unnecessary loss of load and field operation cost. In most situation, the response speed of simple overcurrent reclosers is bottlenecked due to the need for coordination as they need to wait out a delay designated by the inverse-time curve. As mentioned in Sec. 1, in systems with DG, the fault current measured at the substation is smaller than the fault current measured at the faulty lateral, which can cause significant coordination problems [10] [11] because smaller recloser current means the recloser might open slower than the melting speed of the lateral fuse. RL relays do not suffer from this problem since their response time is not correlated with fault current magnitude. To demonstrate this, the substation relay is re-trained to trip as soon as possible after faults regardless of fault location to test the response speed, which is recorded in the following table:

TABLE 4
Response speed of substation RL relay in 2000 episodes

| | | | 3 and | Max | |
|---|---|---|---|---|---|
| Scenario | 1 Step | 2 Steps | above | Delay | Average |
| Lateral Fault | 916/2000 | 77/2000 | 42/2000 | 4 | 1.1613 |
| Feeder Fault | 965/2000 | 0/2000 | 0/2000 | 1 | 1 |
| Total | 1881/2000 | 77/2000 | 42/2000 | 4 | 1.0835 |

The time step used in this simulation is 1/10 cycle in 60 Hz system, equally 1.67 ms per step. During the 2000-episode test, the longest operation delay after the fault is only 4 steps, equally 6.66 ms. In contrast, the melting time of a typical commercial time-delay fuse [19] when the current is 50 times over its nominal current is about 20 ms. Based on this calculation, the RL recloser responds much quicker before the fuse melts, regardless of system status, fault parameter and fault location. Therefore, they can sufficiently protect lateral fuses from melting during transient faults. As a rough comparison, in the study done in [11], the addition of a synchronous DG at bus 840 could cause coordination failures in up to 62% of cases.

6. Concluding Remarks

This paper introduces and tests a possible reinforcement learning (RL)-based protective relay in a modified IEEE 34-node test feeder system. Compared to conventional relays, the proposed relay algorithm demonstrates much higher performance in terms of accuracy, robustness and response speed. This is of particular importance when the distribution system has many distributed energy resources (DERs) such as solar generation. Our future work includes testing the purposed work using realistic system and EMTP simulator, investigating feasibility for practical implementation and Hardware-in-the-Loop testing in RTDS.

### REFERENCES

[1] U.S. Dept. of Energy. “The potential benefits of distributed generation and the rate related issues that may impede its expansion”, (2007)

[2] U. Shahzad, S. Kahrobaee, S. Asgarpoor. “Protection of distributed generation: challenges and solutions”. (Energy and Power Engineering, 2017)

[3] W. El-Khattam, T. S. Sidhu, “Restoration of directional overcurrent relay coordination in distributed generation systems utilizing fault current limiter”, (IEEE Transaction on Power Delivery, vol. 23, no. 2, 2008)

[4] H. Zhan et al., “Relay protection coordination integrated optimal placement and sizing of distributed generation sources in distribution networks”, (IEEE Transaction on Smart Grid, vol. 7, no. 1, 2016)

[5] H. A. Abyane, K. Faez, H. K. Karegar, “A new method for overcurrent relay (O/C) using neural network and fuzzy logic”, (IEEE TENCON '97, 1997)

[6] D. N. Vishwakarma, Z. Moravej, “ANN based directional overcurrent relay”, (2011 IEEE/PES Transmission and Distribution Conference and Exposition, 2001)

[7] Y. Zhang, M. D. Ilić, O. Tonguz, “Application of Support Vector Machine Classification to Enhanced Protection Relay Logic in Electric Power Grids”, (Large Engineering Systems Conference on Power Engineering, 2007)

[8] X. Zheng et al., “A SVM-based setting of protection relays in distribution systems”, (IEEE Texas Power and Energy Conference, 2018)

[9] IEEE PES AMPS DSAS Test Feeder Working Group, “IEEE 34-bus feeder”, (2010), retrieved: http://sites.ieee.org/pes-testfeeders/resources/

[10]J. Silva, H. Funmilayo, K. Butler-Purry, “Impact of distributed generation on the IEEE 34 node radial test feeder with overcurrent protection”, (39th North American Power Symposium 2007)

[11] A. F. Naiem, Y. Hegazy, A. Y. Abdelaziz, A. Elsharkawy, “A novel protection methodology for distribution systems equipped with distributed generation”, (International Electrical Engineering Journal Vol. 6 No.10 pp. 2048-2057, 2015)

[12] North American Electric Reliability Corporation,“Gas turbine governor modeling”, (2017), retrieved: https://www. nerc. com/comm/PC/N ERCModeling Notifications/Gas_Turbine_ Governor_Modeling .pdf

[13] R. S. Sutton and A. G. Barto, “Reinforcement learning: an introduction”, (MIT Press, 2nd Edition, 2018)

[14] V. Mnih et al., “Human-level control through deep reinforcement learning”, (Nature, vol. 518, pp.529-533, 2015)

[15] D. Braziunas, “POMDP solution methods”, (University of Toronto, 2003)

[16] D. Wu, X. Zheng, D. Kalathil, L. Xie, “Nested Reinforcement Learning Based Control for Protective Relays in Power Distribution Systems”, (arXiv preprint, 2019)

[17] M. Abadi et al., “TensorFlow: Large-scale machine learning on heterogeneous systems”, (2015), Software available from tensorflow.org

[18] M. Plappert, Keras-rl, (GitHub Repository, 2016), retrieved: https://github.com/keras-rl/keras-rl

[19] Cooper Industries, “15.5 kV E-Rated medium voltage fuses for feeder circuit, switchgear and transformer protection”, (2018), retrieved: http://www.cooperindustries.com/content/public/en/bussmann/ electrical/products/medium_voltage/e-rated-fuses.html

Deep Reinforcement Learning-Based Robust Protection in DER-Rich Distribution Grids

I. Introduction

This paper proposes and conceptually tests a novel Deep Reinforcement Learning (Deep RL) based approach for protective relay control design in distribution grids. Recent developments in photovoltaic (PV) and power electronics technology have led to an increase in the penetration of distributed energy resource (DER) in the distribution grids. DERs, especially solar PVs, can provide a number of benefits to the power system operation efficiency such as peak load reduction and improved power quality [1].

However, DER and emerging grid edge-level devices are increasing the complexity of the interactions between end users and distribution grid operators substantially, such as low or non-existent system inertia, islanded operation and load-side voltage security. These additional complexities pose significant challenges to the operation and protection of the distribution grid.

Protective relays are the safeguards of distribution systems. The role of protective relays is to protect the grid from sustaining faults by disconnecting the smallest practically available faulty segment from the rest of the grid. During the operation, a relay monitors the power grid and looks for patterns that signifies faults. Typical measurements include current (overcurrent and differential relay), voltage and current (distance relay), frequency or electromagnetic wave from transients (traveling-wave relay). In power distribution systems, time delayed, coordinated overcurrent relays are most commonly used since many other methods are impractical due to cost, infrastructure and grid topology limitations.

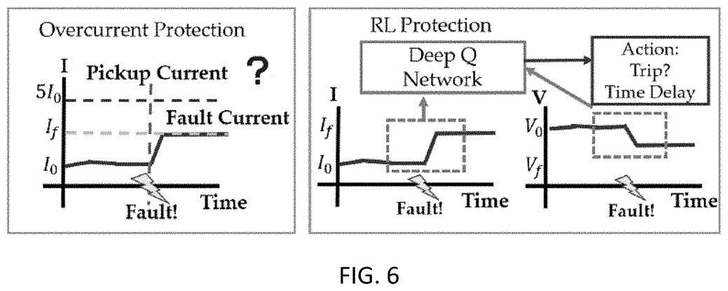

However, it is very difficult for overcurrent relays to accommodate the vastly different operation conditions in real distribution grids. For feeder recloser relays, the presence of DER within the feeder can reduce the fault current measured at the recloser and make faults harder to detect. The fault current contribution from DERs to the fault will also make the fault current observed at the fuse higher than the current at the recloser, making coordination based on inverse-time curves difficult [2] [3]. Moreover, even in current distribution grids, factors like fault impedance and load profile change are not taken into account in the traditional overcurrent protection design, resulting in problems such as failing to detect faults near the end of a feeder, a.k.a. under-reaching. FIG. 6 shows a conceptual comparison between threshold-based overcurrent protection and our proposed RL protection. Where overcurrent relays may be affected by low fault current magnitude, our method does not suffer the same limitation as it detect faults using the patterns in measurements.

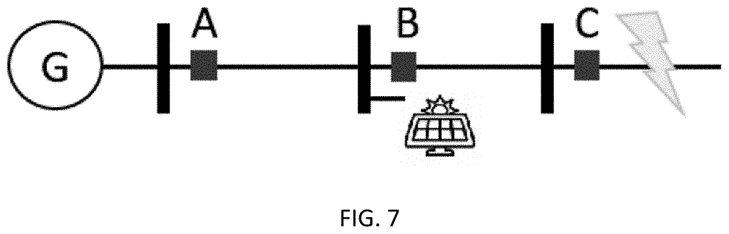

Traditional protective relays are also designed to function under two crucial assumptions: (i) power flow is unidirectional from the substation towards the end users, and (ii) the difference between operating conditions (currents and voltages) between normal and faulted conditions are measurable and significant. With the increasing penetration of DER and gridedge devices, both assumptions will likely be rendered invalid [2]. For example, in the simple circuit shown in FIG. 7, there is a distributed generator feeding power into the grid at bus B. Under conditions where the net power absorption of the loads at bus B and C is low, or the output of the distributed generator at B is having a high peak, the power flow direction in the line between A and B will be from B to A, which violates assumption (i). For a fault to the right of bus C as indicated in the figure, the fault current contribution of the distributed generator could decrease the magnitude of fault current measured at the recloser in bus A to the range of peak load current under normal conditions and potentially violating assumption (ii). In fact, reliable protection is becoming a bottleneck in the deep DER integration DER for future grids.

A. Literature Review There are many studies on improving the performance of protective relays. Most of them focus on improving the performance of commonly used overcurrent relays by better fault detection [4] and coordination [5]. Neural networks are used in setting the parameters of overcurrent relays [6]. Support Vector Machine (SVM) can be trained to distinguish the normal and fault conditions directly [7][8]. A recent work [9] uses tabular Q-learning to find the optimal setting for overcurrent relays. Most proposed methods are still confined within the framework of inverse-time overcurrent protection, which is considered not enough for the future distribution grid with high DER and EV penetration [2].

Reinforcement Learning (RL) is a branch of machine learning that addresses the problem of learning optimal control policies for unknown dynamical systems. RL algorithms using deep neural networks [10], known as Deep RL algorithms, have made significant achievements in the past few years in areas like robotics, games, and autonomous driving [11]. RL has also been applied to various power system control problems including voltage regulation [12], frequency regulation [13], market operation [14], power quality control [15] and generator control [16]. Our previous paper [17] was the first work to use deep RL for power system protection. It introduced a sequential training algorithm for the coordination between multiple RL-based relays in the distribution system. A comprehensive survey of RL applications in power system is detailed in a recent review paper [18].

B. Main Contributions

This paper describes a novel deep RL based solution to address the protective relay control problem under distribution grids with high DER penetration. This approach combines recent advancements in machine learning and domain knowledge on power system operations. Main contributions are summarized as follows:
Formulation of the optimal protective relay control problem as an RL problem.
A novel Long-Short-Term-Memory (LSTM)-enhanced RL algorithm for reliable fault detection and accurate coordination of protective relays, which use the exactly same information available to today's inverse-time overcurrent relays can potentially develop more accurate, faster and consistent performance.
A fully automated learning interface between the machine learning packages and power system simulators

II. Problem Formulation

In this section, we give a brief review of RL and formulate the relay control problem under the RL framework.

A. Relay Operation

We first illustrate the ideal operation of relays using a simple distribution feeder as given in FIG. 7. There are 3 relays and breakers located at each bus of the distribution line. Each relay is located to the right of a bus. Each relay needs to protect the segment that is between its location and the buses and loads located downstream. The protection of inverter-based generators is not considered to be part of the functions of the relays. Thus, it effectively isolates inverters from the rest of the network. Each relay except relay C is also required to provide backup protection for its downstream neighbor: when its neighbor fails to operate, it needs to trip the line and clears the fault after a reasonably short wait time. For example, in FIG. 7, if a fault occurs at the point where the broken arrow indicator is, relay C is the main relay protecting this segment and it should trip the line immediately. If relay C fails to work, relay B, which provides backup for relay C, needs to trip the line instead, after a short delay of the order of a fraction of a second. The time delay between the fault occurrence and relay tripping should be as short as possible for primary relays, while backup relays should react slower to ensure that they are triggered only when the corresponding primary protection relay is not working. The coordination time between primary and backup protection should be short enough to allow the aggregate coordinated time response at the relay closest to the substation to effectively trip the fault currents.

B. Reinforcement Learning and Modeling of RL Relay

Reinforcement learning (RL) is a sub-field of machine learning that focuses on learning to control dynamic systems. In RL formulations, a control problem is modelled as an active interaction between the controller, a.k.a. Agent, and the system, or environment, to be controlled. The system is represented by a Markov chain whose state evolves based on a deterministic or stochastic transition kernel as well as the actions of the agent. The agent observes the state of the system and give control actions based on its policy. Each action is assigned a reward that is based on the effect of the action and the resulting state transition. In the process of solving an RL problem, the agent learns a control policy that gives the most optimal action corresponding to each observed system state in order to maximize total expected reward. Unlike traditional control problems in which the controller is derived from analytical analysis on an accurate model of the system or plant, an RL agent learns its optimal policy through sequential observation and perturbation of the system state. The RL agent typically assume no prior knowledge about the system model at the beginning of learning, it then gather experience about the system state transition and reward by attempting different actions under different states. After enough experience is collected, the agent will be able to choose the actions that results in the highest long-term reward based on the observations it receives.

C. Markov Decision Processes and Reinforcement Learning

Next, we will proceed to give a brief review of the basic concepts of Markov Decision Process (MDP) and RL and then present a mathematical formulation of the protective relay problem. This formalism will be expanded later to formulate the optimal control for relay protection problem under the framework of multi-agent reinforcement learning. A concise but more comprehensive introduction of MDP, Dynamic Programming (DP) and RL could be found at [19].

MOP and RL are described above with reference to “Nested Reinforcement Learning Based Control for Protective Relays in Power Distribution Systems.”

The standard Q-learning algorithm as described cannot be directly used in problems with continuous state/action space. For continuous problems, a deep neural network is usually used as a replacement for an explicit Q-function: Q(s, α)≈Qₙ(s, α) and n represents parameters of the neural network. The neural network for Q-learning is usually called Deep-Q-Networks (DQN). The ability of neural networks to approximate any function using only input-output samples has enabled tremendous success in many reinforcement learning problems in different fields.

For each state-action pair (sₜ, αₜ, Rₜ, sₜ₊₁), the parameters of the DQN can be updated using stochastic gradient descent:

$$n = n + α ∇ {Q}_{n} ( {s}_{t} , {a}_{t} ) ( {R}_{t} + {γmax}_{b ∈ A} {Q}_{n} ( {s}_{t + 1} , b ) - {Q}_{n} ( {s}_{t} , {a}_{t} ) ) \qquad ( 2 )$$

Q-learning with neural network can be improved by implementing various upgrade techniques. Experience replay is used as a buffer to store a batch of observations and shuffle them before each gradient upgrade. This can help to avoid the bias introduced by the temporal correlation among observations obtained in a sequence. Target network is a separate neural network model only used to temporarily fix the gradient descent target for several steps to avoid potential instability caused by chasing a moving target.

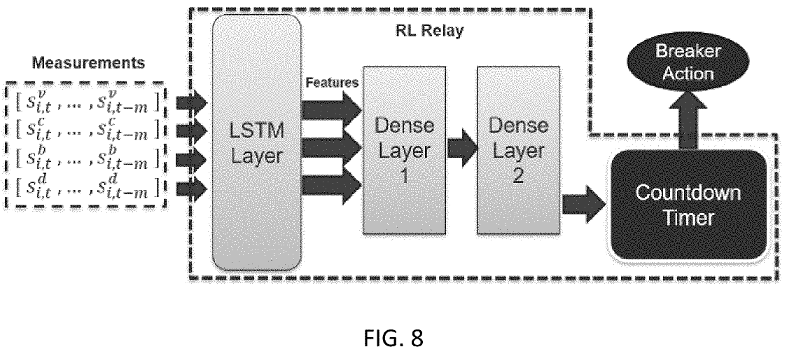

An Long-Short-Term-Memory(LSTM) layer [21] is used before the fully-connected layers to extract features from time series inputs. Using LSTM with deep reinforcement learning [22] has received increasing attention in recent years in time-correlated control problems. LSTM has a unique advantage over other non-recurrent neural network models, that is, the ability to remember what have happened in the past. Each LSTM cell has a internal state that can be either kept/changed/forgot for every observation it receives. This feature is particularly useful for assessing the current state of power systems, as it is able to adapt to the change of states incurred by other disturbances that does not need protection to operate (e.g. daily load curve, renewable generation profile, etc.). Our algorithm is based upon the combination of deep neural networks, experience replay, target network and LSTM feature extraction as illustrated by the flowchart in FIG. 8.

D. Protective Relay Control as an RL Problem

We formulate the distribution system transient process as an MDP environment and model the relays as RL agents. For consistency with the current protection infrastructure, each relay is set to only observe its local current measurements (sᵢ^{c},t), although if additional information(voltage, frequency, etc.) is added in to the state space the RL relay would easily accommodate them without changing the formulation and potentially achieve even better performance. Each relay also knows the status of the local current breaker circuits, i.e., if it is open or closed (sᵢ^{b},t). Each relay also has a local counter that ensures the necessary time delay in its operation as a backup relay (sᵢ^{d},t). These variables constitute the state s_{i,t}=(s_{i,t}^{c}, s_{i,t}^{b}, s_{i,t}^{d}) of each relay i at time t. Table I summarizes this state space representation.

TABLE I
Relay State Space

| State | Description |
|---|---|
| s_{i, t}^{c} | Local current measurements of past m timesteps |
| s_{i, t}^{b} | Status of breaker (open (0) or closed (1)) |
| s_{i, t}^{d} | Value of the countdown timer |

Note that the each state also uses the past m measurements to form a timeseries of measurement with length m+1. An appropriate combination of sampling rate and length of the timeseries allow one to deal with some classes of transients that cannot be identified from phasor measurements (such as inverter controls and limiters) in order to determine post-transient state.

Relay should operate after faults occur. However, since each relay is able to observe only its local state and no communication is assumed between the relays, some implicit coordination between relays is necessary. In traditional overcurrent protection scheme, the coordination is achieved using an inverse-time curve that adds a time delay between the detection of fault and actual breaker operation, based on the variation among fault current magnitudes at different locations on the feeder. However, fault current magnitudes can be unpredictable across different scenarios, especially with DER and smart edge-devices. We propose another approach (that is also amenable to RL) as follows. Instead of tripping the breaker instantaneously, it controls a countdown timer to indirectly operate the breaker. If a fault is detected, the relay can set the counter to a value such that the breaker trip after a certain time delay. The counter could be cancelled prematurely if the fault is cleared by another protective device. The action of each relay i at time t, α_{i,t} is summarized in table II.

TABLE II
Relay Action Space

| Action | Description |
|---|---|
| αₛₑₜ | Set the counter to value to an integer between 1 and 9 |
| α_{d} | Decrease the value the counter by one |
| αᵣₑₛₑₜ | Stop and reset the counter |

The reward given to each relay is a measure of success for its most recent action. A positive reward is given to an RL relay if: i) it remains closed during normal conditions, ii) it trips the breaker after a fault in the downstream circuit where it is the closest protection device, or when other closer protections fail to operate. A negative reward is given if: i) tripping the breaker when there is no fault, or the fault is outside of its assigned region; 2) fail to trip the breaker when a fault is present in its assigned region. The magnitude of the rewards are designed to implicitly signify relative importance of false positives (lack of dependability) and false negatives (lack of reliability). The reward function for each relay is shown in Table III.

TABLE III
Reward for Different Operations

| Reward | Condition |
|---|---|
| Large Positive | Tripping when a fault is present in its |
| | assigned protection region |
| Large Negative | Tripping when there is no fault or the |
| | fault is outside its assigned region |
| Small Positive | Stay closed when there is no fault or the |
| | fault is outside its assigned region |
| Small Negative | Stay closed when a fault is present in its |
| | assigned protection region |

The transition probability in a distribution feeder with multiple RL relays relates the change in power flow states to the measurement and operation of RL relays. Formally, let the global state at time t. s̅ₜ=(s_{1,t}, s_{2,t}, . . . , s_{n,t}), denote all nodal voltage and branch current in the system; let the combined action at time t, α̅ₜ=(α_{1,t}, α_{2,t}, . . . , α_{n,t}), denote the action of every RL relay in the system. Then, the state of the system s̅ₜ evolves stochastically based on α̅ₜ plus the variation in load profile, DER output and circuit connectivity. Note that the global state evolution cannot be described by local transition probabilities of individual relays because the action of any relay can affect the states of other relays. The global system dynamics is represented by the transition probabilityt P̅(s̅ₜ₊₁|s̅ₜ, α̅ₜ).

The goal in the multi-agent RL formulation is to achieve a global optimum which maximizes the expected sum of reward received by all relays, using only local control laws πᵢ on local observations

$${s}_{i , t} : {max}_{{( {π}_{i} )}_{i = 1}^{n}} 𝔼 [ {\sum }_{t = 0}^{∞} {γ}^{t} {R}_{t} ] , {a}_{i , t} = {π}_{i} ( {s}_{i , t} ) .$$

Local policies πᵢ need to be computed individually as a centralized policy would not be possible due to lack of communication.

III. Nested Reinforcement Learning for Control of Protective Relays

In many distribution feeders there would be multiple protection devices coordinating with each other to provide extra security. However, obtaining the policies for a network of distributed RL relays operating in the same system could be difficult because, 1) Normal RL methods require the environment to appear stationary to the agent; 2) The whole system state in a power grid is not observable using measurements collected from only one location. Multi-Agent-RL (MARL) [23] problems are often untrackable and the performance of available algorithm is generally not reliable.

We proposed a Nested Reinforcement Learning algorithm that cleverly taking advantage of the radial structure of distribution systems to simplify the otherwise difficult MARL problem. In radial distribution systems, the dependency between the operation of coordinating relays is uni-directional, i.e., only upstream relays need to provide backup for a downstream relay but not vice-versa. Also, the last relay at the load side does not need to coordinate with others. In our nested RL algorithm, we start the RL training from the the most remote relay from the distribution transformer whose ideal operation is not affected by the operation of other relays, thus can be trained using a single-agent algorithm.

Then, we can fix the trained policy for this last relay and train the relays at one-level closer to the substation that need to provide backup for the last relay. Since the policy of the furthest relay is fixed, it appears like a part of the stationary environment to its upstream neighbors which can learn to accommodate its operation. This process can be repeated for all the relays upstream to the substation.

This method is analogous to how the coordination of time-delayed overcurrent relays is performed. The order of training can be determined by network tracing using a post-order depth-first tree traversal with the substation being the root. This nested training approach which exploits the nested structure of the underlying physical system allows us to overcome the nonstationarity in generic multi-agent RL settings. Our nested RL algorithm for training a system with n RL relays is formally presented below.

Algorithm 1 Nested Reinforcement Learning Algorithm

Initialize DQN of each relay i with random weights
Sort all relays based on system topology
for relay i = 1 to n do

for episode k = 1 to K do

Initialize simulation with random system parameters
for time step t = 1 to T do

Observe the state s_{i,t} for all relays
for relay j = 1 to i (Trained Relays) do

Select action using the trained policy as:
a_{j,t} = arg maxₐ Qₙ_{ⱼ}*(s_{j,t}, a)

end for
for relay j = i + 1 to n do

Select do nothing action, a_{j,t} = 0

end for
With probability ϵ select a random action a_{i,t}, oth-
erwise select the action with the highest Q value:
a_{i,t} = arg maxₐ Qₙ_{ᵢ} (s_{i,t}, a)
Observe reward R_{i,t} and next state s_{i,t+1}
Store (s_{i,t}, a_{i,t}, R_{i,t}, s_{i,t+1}) in the replay
buffer of relay i
Sample a batch of past transitions from replay buffer
and update the DQN parameter wᵢ

end for

end for

end for

IV. Experiment Environment and Test Cases

In this section, we describe the simulation environment, test system modelling and experiment design.

A. Simulation Environment

The simulation environment is built by packing the OpenDSS APIs in a Python class inherited from the OpenAl Gym [28] to improve accessibility. We note that this setting can potentially be used in a number of other research problems addressing the distribution systems operation using machine learning. The RL algorithm is programmed in Python using open-source machine learning packages Tensorflow [29].

B. Test System Modeling

We choose the IEEE 34-bus test feeder to test the performance of RL based recloser relay control. The test cases are replicated in OpenDSS using the same parameters provided in IEEE publications [25]. Overall, OpenDSS power flow result and IEEE results agree closely, while the difference is mainly caused by aggregating distributed loads in a dummy bus at the midpoint of each branch. The percentage difference of node voltages between the

OpenDSS simulations and IEEE published values are listed in Table IV.

TABLE IV
Difference Between OpenDSS and IEEE Solution

| % Error | Vₐ | V_{b} | V_{c} |
|---|---|---|---|
| Average | 0.179 | 0.240 | 0.023 |
| Maximum | 0.637 | 0.554 | 0.066 |

The RL recloser relay will be placed at the substation (bus 800), its only task is to respond to faults as quickly as possible. In distribution systems, it is common for large and long feeders to have additional reclosers in the middle of the feeder for additional security. For persisting faults that cannot be cleared by reclosing, the recloser needs to be locked open. In such cases, it is preferred for the closest protection device to operate to reduce the amount of load being disconnected and mitigate the damage. In the following multi-agent coordination study, an additional mid-feeder RL recloser relay will be placed at bus 828 to evaluate the coordination performance between RL relays. The mid-feeder recloser should respond only for faults in the second half of the feeder, and for these faults the substation recloser should operate after a delay.

Modifications to the IEEE cases are done when initializing each episode to simulate the real fluctuations of distribution grids. An episode is defined as a short simulation segment that contains a fault. A scenario is generated for each episode using a random combination of load and DER generation profile, fault parameter and fault location. The load and DER generation capacities are sampled from the COVID-EMDA+ dataset[26], which has the real hourly renewable generation and load data for cities within each RTO region. In the beginning of each episode, a random hour is chosen from the year 2019, and the recorded load profile and PV capacity for Houston, Texas corresponding to that time is used to scale the load and PV generators. The maximum total installed capacity of PV is set to 30% of the total load in the feeder and the locations are randomly scattered throughout all single-phase loads. The randomization of DER placement is only meant to provide singular experimental scenarios, although we are aware of the fact that the placement will have an impact on relay performance and would require more thorough analyses. For larger systems, techniques in [27] could potential be used to reduce the amount of computation power required.

In the middle of an episode, a random fault is added to the system. The fault will occur in a random line and phase(s), have a random impedance from 0.001 ohm to 20 ohm. All types of faults (SLG, LL, LLG, 3-phase) are possible. To match realistic scenarios in distribution lines, single phase faults have the highest chance to be selected and 3-phase faults have the lowest chance. The performance of the RL relays are evaluated by running a large number of random episodes.

C. Overcurrent Protection

To set a baseline for comparison, a simple overcurrent recloser is placed at the substation and is configured to respond to faults in the distribution feeder. The settings of the overcurrent recloser relay is assumed to be twice the nominal current under the base case, in which the load capacities are the same as IEEE published numbers and the substation transformer is the only power supply for the feeder. A midfeeder overcurrent recloser will also be placed at bus 828.

The setting for the two overcurrent recloser relays used for comparison are recorded in Table V.

TABLE V
Settings for Baseline Overcurrent Relays

| Bus | Curve Type | Pickup Cunent(A) | Time Dial |
|---|---|---|---|
| 800 | IEEE Very Inverse | 90 | 0.2 |
| 828 | IEEE Very Inverse | 75 | 0.1 |

The fault detection and coordination of the overcurrent relays are tested under the basic IEEE 34 node feeder without considering any DER or load variation. The results in Table VI shows the overcurrent relays are very reliable under the static environment.

TABLE VI
Performance of Overcurrent Relays in Base Case

| Type | Occurrences | Probability |
|---|---|---|
| False Alarm | 0/5000 | 0% |
| Fail to Detect | 21/5000 | 0.42% |
| Mis-Coordination | 13/5000 | 0.26% |

More specifically, the few times the overcurrent relays fail to detect faults are for single-phase faults in the 4.16 kV buses (888 and 890) with a relatively high fault impedance.

V. Simulation Results

A. Performance Metrics

In this section we present and discuss the performance of our Nested RL algorithm for protective relays. We compare the performance with conventional overcurrent relay protection strategy. The performance is evaluated in three aspects:

Failure Rate: A relay failure happens when a relay fails to operate as it is expected to do. For each episode, we determine the optimal relay action from the type, time, and location of the fault, and compare it to the action taken by the RL based relay. We evaluate the percentage of the operation failures of the relays in four different scenarios: when there is a (i) fault in the local region, (ii) fault in the immediate downstream region, (iii) fault in a remote region, (iv) no fault in the network.

Robustness: The load profiles in power distribution systems is a combined result from factors including renewable generation, load ramping, weather and social events. Moreover, both the total load capacity and renewable penetration are expected to grow consistently each year. Increase in the load capacity can cause a higher peak load and high renewable penetration can increase the variance of the load profile. It would be desirable if the protection system is robust against such changes to avoid the additional cost introduced by reanalyzing and re-programming the relays after deployment. We evaluate the performance of RL relays when the operating condition exceeds the nominal range.

Response Time: The response time of RL relay is defined as the time difference between the inception of the fault and the relay decision and action. Response time is extremely critical in preventing hazards. For example, it is preferred for the substation recloser to attempt clearing transient faults before any fuse in the feeder melts. This requires the recloser to have a fast fault detection time. We compare the response time of the RL based relays with the conventional overcurrent relays.

B. Performance: Single Agent RL

We first present the performance of our RL algorithm for a single recloser control. This is a special case of the proposed algorithm (with n=1). We train and test our algorithm in the context of substation recloser control in distribution feeders. In particular, we consider a recloser located at the substation. The IEEE 34 bus feeder is used in this experiment.

We have run the simulations with both the overcurrent protection and RL protection programmed in the same simulation setting. The same sequence current measurement from OpenDSS is provided to both the overcurrent and RL relay. The RL relay will remember each measurement value for a few steps and use the time window as input, while the overcurrent relay could be triggered by each incoming measurement snapshot. The simulation is run for 5000 randomly generated episodes and the operation of RL relay and overcurrent relay is logged and compared.

Table VII summarizes the failure rate performance of both the RL relay and overcurrent relay in 34 bus test feeder.

TABLE VII
Failure Rate of Relays Under 30% DER

| | | | |
|---|---|---|---|
| Scenario | False Operation | Occurrences | Probability |

RL Based Relay

| | | | |
|---|---|---|---|
| No Fault | Trip | 0/5000 | 0.00% |
| Faulted | Hold | 16/5000 | 0.32% |

Overcurrent Relay

| | | | |
|---|---|---|---|
| No Fault | Trip | 0/5000 | 0.00% |
| Faulted | Hold | 773/5000 | 15.46% |

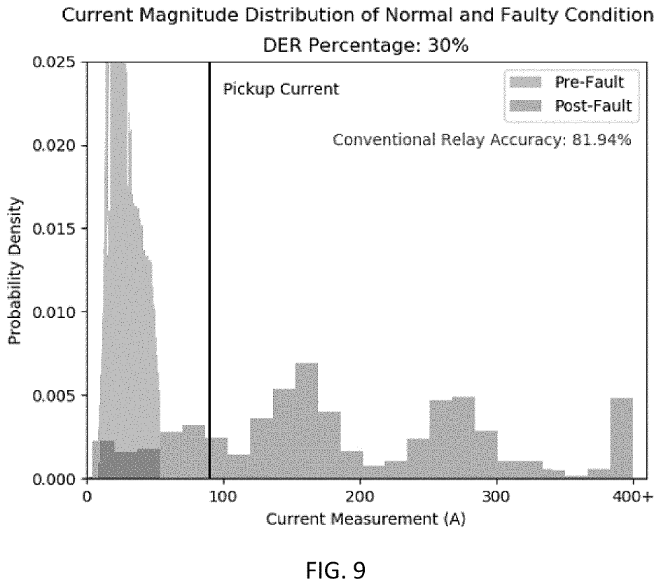

The RL based relays are extremely accurate even under very high DER penetration levels. The fault current contribution from DER and fault impedance can, under many cases, reduce the magnitude of fault current measured at the substation (bus 800) considerably. As shown in FIG. 9, the fault current magnitude can be very close to the normal load current range for faults near the end of the feeder, high-impedance faults or faults in the two 4.16 kV buses. Under these scenarios, a fixed pickup current can never completely separate the normal and fault condition because their distributions are overlapping.

To quantify the robustness of RL based algorithm against peak load variations, the total load capacity the system is increased to 30% more than the peak capacity used to generate the training data. In creating the validation data for robustness assessment, we focus on the robustness only when the system load is around the peak. For evaluating the robustness at 10% higher load, the data is only selected when the system load is between 100% and 110% of the original capacity. Note that the model and policy of the RL relay remain unchanged, which means the data samples at the higher load are not used in training.

Similarly, we also evaluate the robustness against potential increase in DER penetration. As the capacity of DERs in the distribution systems is expected to increase over time, it is desirable that the protection devices can reliably function without the need to re-configure their settings. In this experiment, the RL relays are trained using data created assuming an up to 30% DER penetration as described in Sec. IV, B. The obtained policy is tested under scenarios where the DER penetration is increased above 30%. The results are shown in the bottom half of Table VIII.

TABLE VIII
Robustness Against Peak Load and DER Increase

| | 10% | 20% | 30% |
|---|---|---|---|
| Peak Load Increase | | | |
| RL Failure Rate | 0.38% | 0.36% | 0.40% |
| Overcunent Failure Rate | 6.5% | 7.4% | 9.8% |
| Peak DER Increase | | | |
| RL Failure Rate | 0.48% | 0.56% | 0.88% |
| Overcurrent Failure Rate | 18.5% | 19.7% | 22.9% |

It can be seen that the RL relay is able to retain a good performance even when the DER penetration exceeds the amount that it is designed to operate on.

We also measure the response time during the tests, quantified in terms of the number of simulation steps where each simulation step is 0.002 second. This step length is limited by the computation speed of the deep neural network model, which could be significantly improved with highly likely advances in hardware and software. The RL relays have shown a very small response time as listed in Table IX, the longest delay is 4 simulation steps which corresponds to 8 ms.

TABLE IX
Response Speed After Faults

| Delay | 1 Step | 2 Step | 3 Step | 4 Steps |
|---|---|---|---|---|
| Occurances | 0/5000 | 4981/5000 | 17/5000 | 2/5000 |

Moreover, the response time is not correlated with fault current magnitude, and is much faster than the melting time curve of typical time-delay fuses. We note that, in practice however, the response time could be limited by the data acquisition rate of current measurements of instrument transformers.

C. Performance: Multi-Agent RL

Our nested RL algorithm makes use of the radial structure of distribution grids. By this approach, if a relay need to provide backup for a downstream neighbor, it learns the optimal time delay before tripping the breaker for each possible fault scenario to accommodate the policy of its neighbor.

The failure rate of the recloser pair is measured based on the action of both relays. An episode is considered successful only if both recloser take the correct control actions. The operation is tested in 5000 random episodes and the result is summarized in Table X.

TABLE X
Failure Rate of Multi-Agent Relays

| | | |
|---|---|---|
| Scenario | Occurrences | Probability |

RL Based Relay

| | | |
|---|---|---|
| False Alarm | 0/5000 | 0.00% |
| Fail to Detect | 19/5000 | 0.38% |
| Coordination Failure | 64/5000 | 1.28% |

Overcurrent Relay

| | | |
|---|---|---|
| False Alarm | 0/5000 | 0.00% |
| Fail to Detect | 696/5000 | 13.92% |
| Coordination Failure | 315/5000 | 6.30% |

Robustness against increased peak load and DER capacity are conducted for the two-recloser pair similar to the single recloser scenario. A mis-operation of one recloser is recorded as failure for the entire episode. The results are listed in Table XI.

TABLE XI
Robustness Against Peak Increase: Multi-Agent

| | 10% | 20% | 30% |
|---|---|---|---|
| Peak Load Increase | | | |
| RL Failure Rate | 0.62% | 0.69% | 0.83% |
| Overcurrent Failure Rate | 7.1% | 8.8% | 10.4% |
| Peak DER Increase | | | |
| RL Failure Rate | 1.02% | 1.16% | 1.30% |
| Overcurrent Failure Rate | 20.6% | 21.5% | 22.9% |

The impact of peak shift is slightly more evident than in previous single-relay cases due to the need for coordination and the performance of RL relays starts to deteriorate at around 15% increased peak.

The response time for the both reclosers is recorded in Table XII.

TABLE XII
Response Time

| | | | | 4+ |
|---|---|---|---|---|
| Delay | 1 Step | 2 Step | 3 Step | Steps |
| Mid-feeder recloser | 0/5000 | 4962/5000 | 28/5000 | 10/5000 |
| | 3− | | | 6+ |
| Delay | Step | 4 Step | 5 Step | Steps |
| Substation recloser | 2910/5000 | 345/5000 | 1591/5000 | 154/5000 |

It can be seen that the substation recloser responds faster to faults that are between the substation and the midfeeder recloser. For faults in the right half of the circuit, the substation recloser provides a time window of roughly 3 time steps for the closer neighbor to operate first.

VI. Concluding Remarks

This paper introduces and thoroughly tests a deep reinforcement learning based protective relay control strategy for the distribution grid with many DERs. It is shown that the proposed algorithm builds upon existing hardware and uses the same information available to today's overcurrent protection yields much faster and more consistent performance. This algorithm can be easily applied in both a standalone relay and a network of coordinating relays. The trained RL relays can accurately detect faults under situations including high fault impedance, presence of distributed generation and volatile load profile, where the performance of traditional overcurrent protection deteriorates heavily. The RL relays are robust against unexpected changes in operating conditions of the distribution grid at the time of planning, eliminating the need to re-train the relays after deployments. The fast response speed provides ample time for coordinating with fuses and other relays.

The proposed deep RL relays are easy to implement with the currently available distribution infrastructure. A particularly attractive feature is that the proposed algorithm for relays can operate in a completely decentralized manner without any communication. This communication-free setting is not only easy to implement for currently available distribution grid infrastructure, but also less vulnerable to potential cyberattacks. The input to the RL relays are the same as traditional relays so the instrument transformers can be retained during deployment. The training process does not require human intervention since the production of training data and computation of optimal control policy can be fully automated. The weights of the DON obtained during training can be saved into a general-purpose micro-controller or potentially a more optimized machine learning chip.

### REFERENCES

[1] U.S. Dept. of Energy, The potential benefits of distributed generation and the rate related issues that may impede its expansion, 2007.

[2] U. Shahzad, S. Kahrobaee, S. Asgarpoor, Protection of distributed generation: challenges and solutions, Energy and Power Engineering, vol.9, pp. 614-653, 2007.

[3] J. Silva, H. Funmilayo and K. Butler-Puny, Impact of distributed generation on the IEEE 34 node radial test feeder with overcurrent protection, 89th North American Power Symposium (NAPS), 2007.

[4] P. Dash, S. Samantaray and G. Panda, Fault classification and section identification of an advanced series-compensated transmission line using support vector machine, IEEE transactions on power delivery, vol. 22, no. 1, pp. 67-73, 2007.

[5] H. Zhan et al., Relay protection coordination integrated optimal placement and sizing of distributed generation sources in distribution networks, IEEE Transactions on Smart Grid, vol. 7, no. 1, pp. 55-65, 2016.

[6] H.-T. Yang, W.-Y. Chang, and C.-L. Huang, A new neural networks approach to on-line fault section estimation using information of protective relays and circuit breakers, IEEE Transactions on Power Delivery, vol. 9, no. 1, pp. 220-230, 1994.

[7] X. Zheng et al, A SVM based setting of protection relays in distribution systems, 2018 IEEE Texas Power and Energy Conference (TPEC), College Station, Tex., USA, pp. 1-6, 2018.

[8] Y. Zhang, M. D. Ilíc and O. Tonguz, Application of Support Vector Machine Classification to Enhanced Protection Relay Logic in Electric Power Grids, LESCOPE, 2007.

[9] H. C. B. K. Kiran and G. N. Paterakis, Reinforcement Learning for Optimal Protection Coordination, 2018 International Conference on Smart Energy Systems and Technologies (SEST), Sevilla, pp. 1-6, 2018.

[10] V. Minh et al., Human-level control through deep reinforcement learning, Nature, 518.7540:529, 2015.

[11] K. Arulkumaran, M. P. Deisenroth, M. Brundage and A. A. Bharath, Deep reinforcement learning: a brief survey, IEEE Signal Processing Magazine, vol. 34, no. 6, pp. 26-38, November 2017.

[12] H. Xu, A. Dominguez-Garcia, V. Veeravalli and P. W. Sauer, Datadriven voltage regulation in radial power distribution systems, IEEE Transactions on Power Systems, October 2019.

[13] J. Sun et al., An integrated critic-actor neural network for reinforcement learning with application of DERs control in grid frequency regulation, JEPE, vol. 111, pp. 286-299, 2019.

[14] Q. H. Wu and J. Guo, Optimal bidding strategies in electricity markets using reinforcement learning, Electric Power Components and Systems, vol. 32, pp. 175-192, June 2010.

[15] M. Bagheri et al., Enhancing power quality in microgrids with a new online control strategy for DSTATCOM using reinforcement learning algorithm, IEEE access, vol. 6, pp. 38986-38996, 2018.

[16] T.P. lmthias Ahmed, P. S. Nagendra Rao and P. S. Sastry, A reinforcement learning approach to automatic generation control, Electric Power Systems Research, vol. 63, pp. 9-26, August 2002.

[17] D. Wu, X. Zheng, D. Kalathil and L. Xie, Nested reinforcement learning based control for protective relays in power distribution systems, IEEE Conference on Decision and Control (CDC), Nice, France, December 2019.

[18] M. Glavic, (Deep) Reinforcement learning for electric power system control and related problems: A short review and perspectives, Annual Reviews in Control, vol. 48, pp. 22-35, 2019.

[19] M. E. Harmon and S. S. Harmon, Reinforcement Learning: A Tutorial, University of Toronto

[20] R. S. Sutton, A. G. Barto, Reinforcement learning: an introduction, MIT Press, 2nd edition, 2018.

[21] S. Hochreiter and J. Schmidhuber, Long Short-term Memory, Neural computation. 9. 1735-80. 10.1162/neco.1997.9.8.1735., 1997.

[22] B. Bakker, Reinforcement learning with long short-term memory, Advances in neural information processing systems, 2002.

[23] S. Kapoor, Multi-Agent Reinforcement Learning: A Report on Challenges and Approaches, arXiv:1807.09427

[24] R. C. Dugan and T. E. McDermott, An open source platform for collaborating on smart grid research, 2011 IEEE Power and Energy Society General Meeting, Detroit, Mich., USA, pp. 1-7, 2017.

[25] K. P. Schneider et al., Analytic considerations and design basis for the IEEE distribution test feeders, IEEE Transactions on Power Systems, vol. 33, pp. 3181-3188, May 2018.

[26] G. Ruan et al., A Cross-Domain Approach to Analyzing the Short-Run Impact of COVID-19 on the U.S. Electricity Sector, Joule, 2020.

[27] A. Pregelj, M. Begovic and A. Rohatgi, “Quantitative techniques for analysis of large data sets in renewable distributed generation,” in IEEE Transactions on Power Systems, vol. 19, no. 3, pp. 1277-1285, August 2004, doi: 10.1109/TPWRS.2004.831278.

[28] G. Brockman et al., OpenAl gym, arXiv:1606.01540, 2016.

[29] M. Abadi et al., TensorFlow: Large-scale machine learning on heterogeneous systems, Software available from tensorflow.org, 2015.

Although specific examples and features have been described above, these examples and features are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed in this specification (either explicitly or implicitly), or any generalization of features disclosed, whether or not such features or generalizations mitigate any or all of the problems described in this specification. Accordingly, new claims may be formulated during prosecution of this application (or an application claiming priority to this application) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method for determining a control architecture for a network of protective relays of a power distribution system, the method comprising:
receiving data specifying a topology of a plurality of relays in the network of protective relays;
sequentially modelling each relay in the network of protective relays using a reinforcement learning algorithm, including modelling each relay as an agent configured to detect one or more local conditions on the power distribution system and configured to trip based on the one or more local conditions; and
determining, based on the sequential modelling, one or more control parameters for each relay in the network of protective relays.

2. The method of claim 1, wherein the data specifying the topology specifies that the network of relays is organized in a radial topology branching outward from a substation.

3. The method of claim 2, wherein the reinforcement learning algorithm is a nested reinforcement learning algorithm.

4. The method of claim 2, wherein the radial topology branches outwards from a substation to ends of feeder lines.

5. The method of claim 4, wherein sequentially modelling each relay comprises modelling in an order from the ends of the feeder lines to the substation.

6. The method of claim 1, comprising programming relay controllers for each of the relays in the network of protective relays with the one or more control parameters for each of the relays.

7. A computer system comprising at least one processor and memory, wherein the computer system is programmed for determining a control architecture for a network of protective relays of a power distribution system by:
receiving data specifying a topology of a plurality of relays in the network of protective relays;
sequentially modelling each relay in the network of protective relays using a reinforcement learning algorithm, including modelling each relay as an agent configured to detect one or more local conditions on the power distribution system and configured to trip based on the one or more local conditions; and
determining, based on the sequential modelling, one or more control parameters for each relay in the network of protective relays.

8. The computer system of claim 7, wherein the data specifying the topology specifies that the network of relays is organized in a radial topology branching outward from a substation.

9. The computer system of claim 8, wherein the reinforcement learning algorithm is a nested reinforcement learning algorithm.

10. The computer system of claim 8, wherein the radial topology branches outwards from a substation to ends of feeder lines.

11. The computer system of claim 10, wherein sequentially modelling each relay comprises modelling in an order from the ends of the feeder lines to the substation.

12. The computer system of claim 7, comprising programming relay controllers for each of the relays in the network of protective relays with the one or more control parameters for each of the relays.

13. A method for integrating a plurality of reinforcement-learning (RL) based relays into a power distribution system, the method comprising, for a given RL relay:
capturing voltage and current measurements from measurement equipment associated with the RL relay;
storing the voltage and current measurements to form a time window of consecutive voltage and current measurements; and
supplying the time window of consecutive voltage and current measurements to a trained network for the RL relay.

14. The method of claim 9, wherein storing the voltage and current measurements comprises storing the voltage and current measurements in a first-in-first-out (FIFO) ring buffer.

15. The method of claim 9, comprising determining an operation delay for closing the relay using a countdown timer based on a counter control signal from the trained network.
